(19) United States
(12) Patent Application Publication
(10) Pub. No.: US 2022/0101207 A1
(43) Pub. Date: Mar. 31, 2022

(54) INTELLIGENTLY SELECTING AND PROVIDING DESIGNATED INTERSECTION LOCATIONS FOR TRANSPORTATION REQUESTS

(71) Applicant: Lyft, Inc., San Francisco, CA (US)

(72) Inventors: Janie Jia Gu, San Francisco, CA (US); Guy-Baptiste Richard de Capele d'Hautpoul, San Francisco, CA (US)

(21) Appl. No.: 17/034,357

(22) Filed: Sep. 28, 2020

(51) Int. Cl. G06Q 10/02; G06Q 10/04; H04W 4/02; H04W 4/024; G06Q 50/30; G06N 20/00

(52) U.S. Cl. CPC G06Q 10/02; G06Q 10/047; G06N 20/00; H04W 4/024; G06Q 50/30; H04W 4/023

(57) ABSTRACT

This disclosure describes an intersection-location system that can identify a street intersection indicated by a transportation request and select an event location at the street intersection based on intersection-location attributes. For example, the disclosed systems can receive a transportation request identifying a requested location at a street intersection and compare various candidate designated locations at the intersection as potential pickup, drop-off, or waypoint locations. The disclosed systems can compare intersection-location attributes for the different candidate designated locations by comparing predicted arrival times or predicted routes of different transportation providers at (or from) the candidate designated locations. The disclosed systems can further select a designated pickup, drop-off, or waypoint location from among the candidate designated locations for a transportation route based on the transportation request. Upon selecting the designated location, the disclosed systems can provide the designated location for display on one or more client devices.

### BACKGROUND

In recent years, both popularity and usage of on-demand transportation information systems have increased. Indeed, the proliferation of web and mobile applications has enabled requesting devices to utilize on-demand ride sharing systems to identify matches between provider devices (corresponding to vehicles) and requester devices and then coordinate across computing devices to initiate transportation from one geographic location to another. For instance, conventional transportation network systems can determine geographic locations of provider devices and requester devices, generate digital matches between provider devices and requester devices, and further track, analyze, and manage transportation and drop-off of requesters across computer networks. Despite recent advances, conventional on-demand transportation network systems continue to suffer from a number of technical disadvantages.

For example, some conventional ride sharing systems inflexibly determine locations for transportation requests. Often, conventional systems rigidly utilize a static computational model to select locations for transportation requests, regardless of where requested pickup or drop-off locations may occur. Many conventional systems uniformly identify a pickup location or a drop-off location irrespective of whether the location is at an intersection, on a particular side of a street, or has some difficult-to-navigate geography. Furthermore, some conventional systems determine pickup or drop-off locations for transportation requests without consideration for how the requested locations impact logistics of navigation or how the requested locations impact the likelihood of request cancelations.

In addition to inflexibly determining locations, conventional ride sharing systems often determine and provide inaccurate location information in response to transportation requests. Specifically, many conventional systems inaccurately estimate or determine where transportation events will occur, especially for transportation requests involving street intersections. Conventional systems frequently determine locations via a Global Positing System (“GPS”) and provide location indicators for display on devices to indicate the GPS locations. By relying solely on conventional GPS techniques, conventional systems limit the accuracy of locations for pickups, drop offs, waypoints, or other transportation events because GPS data often provides no context for determining where such transportation events are likely to occur at an intersection relative to the location indicated by the GPS data. Thus, while many conventional systems can determine a GPS location effectively, these systems cannot provide any indication regarding where a transportation event will occur with respect to an identified location at an intersection.

Due at least in part to the inflexibility and the inaccuracy of conventional ride sharing systems, many conventional systems inefficiently use computing resources to process and store cancelled or repeated transportation requests. Particularly, conventional systems often waste processing time, processing power, and memory processing large numbers of request cancelations and redundant transportation requests that result from the cancelations. Because conventional systems do not account for various locations at intersections for transportation requests and/or do not consider contextual information that affects navigation and the likelihood of cancelation near intersections, these systems receive and process large numbers of cancelations and redundant requests that include locations at or around intersections. Indeed, as a result of the cumbersome, inaccurate nature of conventional systems, requesters often cancel transportation requests and submit redundant transportation requests out of frustration or out of an inability to locate a transportation vehicle at or near intersections.

These, along with additional problems and issues, exist with conventional ride sharing systems.

### SUMMARY

This disclosure describes one or more embodiments of methods, non-transitory computer-readable media, and systems that can solve the foregoing problems in addition to providing other benefits. In particular, the disclosed systems can identify a location at (or near) a street intersection from a transportation request and select a pickup, drop-off, or waypoint location at the street intersection based on intersection-location attributes of the street intersection. For example, the disclosed systems can receive a transportation request identifying a requested location at a street intersection and compare various candidate designated locations at the intersection as potential pickup, drop-off, or waypoint locations. In some cases, the disclosed systems compare intersection-location attributes for the different candidate designated locations, such as by comparing predicted arrival times or predicted routes of different transportation providers at (or from) the candidate designated locations. The disclosed systems can further select a designated pickup, drop-off, or waypoint location from among the candidate designated locations for a transportation route based on the transportation request. Upon selecting the designated location, the disclosed systems can provide the designated location for display on one or more client devices. Accordingly, in some embodiments, the disclosed systems can determine and provide designated locations at street intersections to improve arrival time of vehicles, increase request fulfillment, and reduce request cancelations by analyzing intersection-location attributes for requesters or transportation vehicles navigating intersections.

### BRIEF DESCRIPTION OF THE DRAWINGS

The detailed description refers to the drawings briefly described below.

FIG. 1 illustrates a block diagram of an environment for implementing a transportation matching system and an intersection-location system in accordance with one or more embodiments.

FIGS. 2A-2B illustrate an example improvement in navigating to a designated pickup or drop-off location as compared to navigating to an initial requested location in accordance with one or more embodiments.

FIG. 3 illustrates an example sequence flow of the intersection-location system identifying a requested location at or near a street intersection and selecting a designated pickup, drop-off, or waypoint location at the street intersection in accordance with one or more embodiments.

FIG. 4 illustrates an example intersection for which the intersection-location system determines intersection-location attributes corresponding to candidate designated locations in accordance with one or more embodiments.

FIG. 5 illustrates applying and/or training an example intersection-location machine learning model in accordance with one or more embodiments.

FIG. 6 illustrates examples of increasing conversion probability and expected fulfillment value in accordance with one or more embodiments.

FIG. 7 illustrates an example graphical user interface for a provider device in accordance with one or more embodiments.

FIGS. 8A-8D illustrate example graphical user interfaces for a requester device in accordance with one or more embodiments.

FIG. 9 illustrates a block diagram of an example computing device including various components of an intersection-location system in accordance with one or more embodiments.

FIG. 10 illustrates an example flow of acts for selecting a designated pickup or drop-off location at a street intersection identified from a transportation request and providing a designated-location indicator for a designated location at an intersection in accordance with one or more embodiments.

FIG. 11 illustrates a block diagram of a computing device for implementing one or more embodiments of the present disclosure.

FIG. 12 illustrates an example environment for a transportation matching system in accordance with one or more embodiments.

### DETAILED DESCRIPTION

This disclosure describes an intersection-location system that can select a pickup, drop-off, or waypoint location associated with a street intersection and provide a designated-location indicator to a requester device for such a selected location by accounting for navigable attributes of different candidate locations around the street intersection. For a given transportation request that indicates a requested location at a street intersection, for instance, the intersection-location system can identify candidate designated locations at the intersection and compare intersection-location attributes for the candidate designated locations. Based on the comparison of attributes, the intersection-location system can select a designated location for a transportation request to achieve a particular objective, such as by selecting a designated location that improves the arrival time, reduces the likelihood of cancelation, and/or improves the likelihood of fulfilling the transportation request. In addition to selecting a designated location for the transportation request, the intersection-location system can also select a transportation provider to fulfill the transportation request based on the intersection-location attributes.

In some embodiments, the intersection-location system can receive a transportation request identifying a requested location associated with a street intersection (e.g., within a threshold distance of an intersection of two or more streets). Based on the transportation request, the intersection-location system can further identify candidate designated locations at the street intersection. The intersection-location system can further determine candidate transportation routes associated with each of the candidate designated locations. Such candidate transportation routes can include alternative routes for a transportation provider to navigate to the candidate designated locations. Further, the intersection-location system can select a designated location from among the candidate designated locations based on intersection-location attributes corresponding to the street intersection. The intersection-location system can also provide the designated location for display within a digital map on a client device.

As just mentioned, the intersection-location system can identify a requested location associated with a street intersection. Indeed, the intersection-location system can receive a transportation request that indicates a requested location associated with an intersection. In some cases, the intersection-location system determines that the requested location is within a threshold distance of a street intersection (e.g., within a threshold distance of one of several corner points or within a threshold distance of a midpoint of the intersection).

After identifying a street intersection, the intersection-location system can identify multiple candidate designated locations for the intersection. More specifically, the intersection-location system can identify a number of candidate locations at an intersection that can be selected as a designated location for performing a particular transportation event, such as a pickup, a drop-off, or waypoint. For example, the intersection-location system can identify a pool of candidate designated locations for the intersection by determining a number of sidewalk corners (e.g., locations where two sidewalks meet along two different roads) connected to the intersection. From the number of sidewalk corners, the intersection-location system can determine a number of candidate designated locations by, for instance, placing a candidate designated location on different sides of each sidewalk corner (for a total of two candidate designated locations per sidewalk corner). In some embodiments, the intersection-location system identifies candidate designated locations based on historical transportation data indicating previous transportation event locations for previous transportation requests.

Upon identifying candidate designated locations, the intersection-location system can determine intersection-location attributes for the candidate designated locations. To elaborate, the intersection-location system can determine intersection-location attributes for a given candidate designated location indicating a measure of effectiveness or practicality for a transportation vehicle or a requester navigating around or to the candidate designated location. Example intersection-location attributes include, but are not limited to, a predicted arrival time for a transportation vehicle to arrive at a candidate designated location, a walking distance for a requester to arrive at a candidate designated location, a likelihood that a transportation vehicle will have to move from a candidate designated location before a requester arrives, a likelihood that a transportation vehicle will make a wrong turn while navigating to a candidate designated location, or a predicted straightness for a route segment associated with a transportation route including a candidate designated location. Additional detail regarding specific intersection-location attributes is provided below with reference to the figures.

In some embodiments, the intersection-location system quantifies different measures of intersection-location attributes or determines different types of intersection-location attributes for different candidate designated locations or for different transportation events (e.g., pickup versus drop-off). For instance, the intersection-location system may quantify different intersection-location attributes for different transportation providers based on current locations or directions of travel for the different transportation providers to perform transportation events at the candidate designated locations. Thus, the intersection-location system can select both a transportation provider to fulfill a transportation request and a designated location based on the intersection-location attributes.

To select a designated location from among the candidate designated locations at an intersection, in some embodiments, the intersection-location system determines and compares intersection-location scores for the candidate designated locations. For instance, the intersection-location system determines intersection-location scores based on intersection-location attributes such as predicted arrival times and walking distances. To generate or determine an intersection-location score for a given candidate designated location, the intersection-location system can combine values assigned to the intersection-location attributes (e.g., by generating a weighted combination). In some embodiments, the intersection-location system weights different intersection-location attributes differently as part of generating intersection-location scores. For example, the intersection-location system can assign a heaviest weight to a predicted arrival time associated with a candidate designated location.

In some embodiments, the intersection-location system utilizes an intersection-location machine learning model and/or an objective function to generate intersection-location scores. For example, the intersection-location system can utilize an objective function to accomplish a particular objective such as increasing an expected fulfillment value for a transportation request based on different possible combinations of candidate designated locations and providers for fulfilling the transportation request. To this end, in some cases, the intersection-location system utilizes an intersection-location machine learning model to generate an input for the objective function. Additional detail regarding generating intersection-location scores is provided below with reference to the figures.

As just mentioned, the intersection-location system can utilize an objective function to inform the selection of designated locations and/or transportation providers. To elaborate, the intersection-location system can determine conversion probabilities (e.g., likelihoods of fulfilling transportation requests) based on intersection-location scores (of different candidate designated locations) and can utilize an objective function to accomplish one or more objectives based on the conversion probabilities. For instance, the intersection-location system can utilize an objective function that informs selection of designated locations and transportation providers to increase expected fulfillment values and/or conversion probabilities based on different candidate designated locations and candidate providers. In some cases, the intersection-location system can consider various combinations of candidate providers, candidate designated locations, and requesters in a system-wide sense to determine which combinations result in increasing conversion probabilities and/or expected fulfillment values. Additional detail regarding the objective function is provided below with reference to the figures.

Based on the intersection-location attributes, expected fulfillment values, and/or the intersection-location scores, the intersection-location system can select a designated location. As suggested above, the intersection-location system can select a designated location for a transportation event, such as a pickup event, a drop-off event, or a waypoint stopping event. For example, the intersection-location system can select a designated location from among the candidate designated locations by selecting a candidate designated location with a highest intersection-location score. In some embodiments, the intersection-location system selects a designated location as the candidate designated location with a shortest predicted arrival time for pickup, drop off, or waypoint. In the same or other embodiments, the intersection-location system selects a transportation provider to fulfill the transportation request by identifying a transportation provider with a shortest predicted arrival time for pickup, drop off, or waypoint. In some cases, the intersection-location system utilizes an objective function to select designated locations that, as a result of their intersection-location scores, increase request fulfillment, reduce request cancelations, and/or increase an expected fulfillment value from transportation requests.

As mentioned above, after selecting a designated location, the intersection-location system can further provide the designated location for display on a client device. For instance, the intersection-location system can provide a visual designated-location indicator for display within a digital map presented on a client device, where the designated-location indicator marks or indicates the designated location. In some embodiments, the intersection-location system provides or displays other intersection-location-specific graphical user interface elements as well. For instance, the intersection-location system can provide, for display on a client device, an initial route segment that indicates a transportation route for navigating to a requested location submitted with a transportation request. Together with the initial route segment, the intersection-location system can further provide, for display on a client device, a modified route segment that indicates a transportation route for navigating to the designated location. In some embodiments, the client device displays the initial route segment and the modified route segment with different colors or with some other distinction to indicate the difference between them.

As suggested above, the disclosed intersection-location system provides several advantages and benefits over conventional ride sharing systems. For instance, the intersection-location system can intelligently select a designated pickup, drop-off, or waypoint location at a street intersection for a transportation request. In contrast to conventional ride sharing systems that do not distinguish intersection locations from other locations, the intersection-location system can determine or select intersection locations that are more effective and/or more practical for use as pickup, drop-off, or waypoint locations than locations indicated by a transportation request. Upon determining such an intersection location, the intersection-location system can also provide graphical user interface elements, such as designated location indicators, for display via client devices to improve the functionality (and efficiency) of identifying intersection locations.

To achieve the new intersection-specific functionality, in some embodiments, the intersection-location system implements an ordered combination of steps using unconventional rules to intelligently select designated locations at intersections, which conventional systems cannot do. For instance, while some conventional systems rigidly determine navigation routes for a vehicle to navigate to requested locations—without consideration for how the requested locations impact a provider or requester's navigational logistics or request cancelations—the intersection-location system compares intersection-location attributes of multiple candidate locations at the intersection to flexibly select a location for the transportation request that will reduce arrival time and/or request cancelations.

In addition to intelligently selecting locations at intersections, the intersection-location system can improve the accuracy with which conventional systems identify locations for transportation events at intersections. By distinguishing requested locations at intersections from other requested locations (e.g., locations not at intersections), for instance, the intersection-location system more accurately identifies locations where transportation events occur at intersections, as compared to conventional systems that make no such distinction. For example, by selecting designated locations based on intersection-location attributes, in some embodiments, the intersection-location system can more accurately select intersection locations at which pickups, drop offs, waypoints, or other transportation events are likely to take place. Compared to conventional systems that determine navigation routes only to requested locations, the intersection-location system more accurately determines transportation-event locations based on requested locations at intersections by identifying alternative locations where performing the transportation event is more efficient in terms of arrival time, walking distance, or route; and/or more practical in terms of a requester or vehicle navigating within or around the intersection. From a determined event location, the intersection-location system can present (or provide for display on a graphical user interface) a designated-location indicator corresponding to a pickup, drop-off, or waypoint location at which a transportation event takes place.

In addition to improved functionality and accuracy, in certain embodiments, the intersection-location system also determines designated intersection locations by integrating location, position, and movement data from GPS devices and/or accelerometers or inertial measurement unit (“IMU”) devices. In contrast to conventional ride sharing systems that rigidly execute static computational models that do not distinguish intersection locations from conventional locations, the intersection-location system can utilize the data obtained via GPS and/or IMUs to determine intersection-location attributes, such as predicted arrival times for providers to arrive at candidate designated locations and walking distances for requesters to arrive at candidate designated locations. Specifically, in some embodiments, the intersection-location system can integrate the location data and the movement data of both requester devices and provider devices into matching analyses to determine combinations of providers, requesters, and candidate designated locations at intersections that result in faster arrival times, increased conversion probabilities, and/or increased expected fulfillment values.

Due at least in part to the intelligent-location selection and flexibility of the intersection-location system, in some embodiments, the intersection-location system also improves the computing efficiency of conventional ride sharing systems. Because of the rigid approach of many conventional systems in analyzing only requested locations, many of these conventional systems waste computing resources processing large volumes of request cancelations and redundant requests that result from frustrated requesters and/or untimely navigation to the requested locations. By contrast, the intersection-location system saves computing resources, such as computing power, processing time, and memory, by receiving and processing fewer request cancelations and redundant requests. Indeed, because the intersection-location system can select designated locations at intersections that improve arrival times and increase the ease and efficiency of performing transportation events, the intersection-location system processes fewer cancelations and, in turn, fewer redundant requests.

As indicated by the foregoing discussion, the present disclosure utilizes a variety of terms to describe features and advantages of the intersection-location system. For example, as used herein, the term “street intersection” (or simply “intersection”) refers to a location where two or more streets meet or cross. For example, an intersection can include a geographic area that includes intersecting streets. In some embodiments, an intersection can include a geographic area that includes more than the intersecting portions of the streets. For example, an intersection can include lengths of the streets outside of the actual intersecting portions. Indeed, an intersection can be defined by a threshold distance along each intersecting street (or by a threshold radius) from a midpoint or from one or more corner points of the intersection. In some embodiments, the intersection-location system identifies a midpoint of an intersection as a point in the geographic center of the cross-section of streets that make up the intersection.

As mentioned above, the intersection-location system can receive a transportation request that indicates a requested location. As used herein, the term “requested location” refers to a location indicated as part of a transportation request. For example, a requested location can refer to a location where a requester desires a particular transportation event to be performed. In some cases, a requested location refers to a requested pickup location where a transportation request indicates a transportation vehicle is to pick up the requester. In other cases, a requested location refers to a requested drop-off location where a transportation request indicates a transportation vehicle is to drop off the requester. In yet other cases, a requested location refers to a requested waypoint location where a transportation request indicates a transportation vehicle is to stop, pass by, or at which some other transportation event takes place.

Based on a requested location indicating an intersection, the intersection-location system can identify candidate designated locations at the intersection. As used herein, the term “candidate designated location” refers to a possible or potential location at an intersection that could be selected as a location for a transportation event. For example, a candidate designated location can include a location where a pickup could occur. As another example, a candidate designated location can include a location where a drop off could occur. As yet another example, a candidate designated location can include a location where a waypoint stop could occur. In some embodiments, the intersection-location system determines candidate designated locations based on historical request data indicating locations where previous transportation events have occurred at a given intersection. In certain implementations, the intersection-location system determines candidate designated locations by placing a candidate designated location on different sides of each sidewalk corner of a given intersection. In the same or different embodiments, the intersection-location system determines candidate designated locations from a stored intersection template of a given intersection that indicates locations for the candidate designated locations.

Relatedly, the intersection-location system can determine transportation routes associated with candidate designated locations. As used herein, the term “transportation route” refers to a path of travel to or from a location, such as from one location to another location. For example, a transportation route can refer to a projected path from a provider's current location to a pickup location of a requester and/or from the pickup location to a drop-off location. Similarly, a transportation route can refer to a route for navigating to (or from) a candidate designated location. In some embodiments, the intersection-location system determines different transportation routes for different candidate designated locations and for different providers' navigation to the different candidate designated locations.

From a pool of candidate designated locations, the intersection-location system can select a designated location for a transportation request. As used herein, the term “designated location” refers to a location chosen, designated, or selected for a provider or requester to participate in or perform a transportation event. For example, a designated location can refer to a location selected from among candidate designated locations. The intersection-location system selects a designated location for a provider to perform a transportation event, such as a pickup, a drop-off, or a waypoint stop for a transportation request.

As mentioned, to select a designated location, the intersection-location system can compare intersection-location attributes associated with different candidate designated locations. As used herein, the term “intersection-location attribute” refers to an attribute or a metric associated with a candidate designated location at an intersection. An intersection-location attribute can refer to an attribute that is associated with an intersection location and that affects (e.g., increases or decreases) a likelihood of receiving a cancelation of a transportation request that includes the intersection location. Conversely, an intersection-location attribute can refer to an attribute that is associated with an intersection location and that affects a likelihood of receiving a confirmation or fulfilling a transportation request that includes the intersection location. Example intersection-location attributes include (i) a predicted arrival time for a transportation vehicle to arrive at the candidate designated location, (ii) a walking distance for a requester to arrive at the candidate designated location, (iii) a likelihood that the transportation vehicle will have to move from the candidate designated location before the requester arrives at the candidate designated location, (iv) a likelihood that the transportation vehicle will make a wrong turn while navigating to the candidate designated location, (v) a number of streets for the requester to cross to arrive at the candidate designated location, (vi) widths of one or more streets for the requester to cross to arrive at the candidate designated location, (vii) a number of medians for the requester to cross to arrive at the candidate designated location, (viii) a number of train tracks for the requester to cross to arrive at the candidate designated location, (ix) a number of stop lights for the requester to navigate to arrive at the designated location, (x) an indication of whether the transportation vehicle will pass by the requester in route to the candidate designated location, and (xi) a predicted straightness for a route segment associated with a transportation route including the candidate designated location.

As mentioned above, the intersection-location system generates or determines intersection-location scores for the candidate designated locations. As used herein, the term “intersection-location score” refers to a score that indicates a measure of effectiveness or practicality for a candidate designated location to facilitate a transportation event, such as a pickup, drop off, or a waypoint stop. For example, in some cases, an intersection-location score indicates a measure of likelihood of receiving a confirmation for, converting, and/or fulfilling, a transportation request that includes a candidate designated location with the intersection-location score. In some cases, the intersection-location system determines intersection-location scores that indicate conversion probabilities or some other input for an objective function. In the same or other cases, the intersection-location system determines intersection-location scores in accordance with an objective function to reduce request cancelations and/or to increase confirmations or fulfilled transportation requests. In some embodiments, for a given intersection, the intersection-location system selects a candidate designated location with a highest intersection-location score as a designated location for a transportation request.

In one or more embodiments, the intersection-location system utilizes an intersection-location machine learning model to determine or generate intersection location scores. As used herein, the term “intersection-location machine learning model” refers to a machine learning model of one or more computer algorithms that can generate intersection-location scores based on intersection-location attributes. In some cases, for instance, an intersection-location machine learning model includes a neural network that can be tuned (e.g., trained) based on vectors representing intersection-location attributes to generate an intersection-location score in the form of a likelihood of fulfillment (e.g., a conversion probability). An intersection-location machine learning model can have a particular machine learning architecture that includes branches of a decision tree, neurons and layers of a neural network, or other constituent components of different types of machine learning models. A card-scan machine learning model can also include tunable parameters, such as internal weights and relationships that are specific to the type of architecture and that are learned via training or tuning the model.

Example machine learning models that can make up all or a portion of the card-scan machine learning model include, but are not limited to, support vector machines (“SVMs”), random forest algorithms, decision trees, autoencoders, and neural networks (e.g., convolutional neural networks, recurrent neural networks, or generative adversarial neural networks). For example, a machine learning model can refer to a neural network that includes an algorithm (or a set of algorithms) that implements deep learning techniques to model high-level abstractions in data. In particular, a neural network can include a model of interconnected artificial neurons (e.g., organized in layers) that communicate and learn to approximate complex functions and generate outputs based on inputs provided to the model.

In some embodiments, the intersection-location system utilizes an objective function to select designated locations based on a particular objective, such as increasing a likelihood of fulfilling a transportation request or increasing an expected fulfillment value from the transportation request. As used herein, the term “expected fulfillment value” refers to an expected or anticipated value associated with fulfilling a transportation request. For example, an expected fulfillment value can include an expected profit from a particular transportation request. Further to the point, in certain implementations, the intersection-location system determines expected fulfillment values across different combinations of providers or transportation vehicles, requesters, and candidate designated locations—corresponding to a geographic region and time period—utilizing an objective function based on the conversion probabilities and fulfillment values. In some cases, an expected fulfillment value refers to a combination of a conversion probability (e.g., a likelihood of fulfillment) and a fulfillment value for a given transportation request. Relatedly, the term “fulfillment value” refers to a value associated with a particular transportation request provided that the transportation request is fulfilled. For example, a fulfillment value refers to a profit from fulfilling a transportation request for a particular combination of a provider or transportation vehicle, a requester, and a candidate designated location. In some cases, a fulfillment value refers to a profit from the transportation request provided that conversion occurs for the transportation request.

As suggested above, the term “transportation provider” (or simply “provider”) refers to a driver (e.g., a human driver or an autonomous-computer-system driver) who operates a transportation vehicle and/or who interacts with a provider device. For instance, a transportation provider includes a person who drives a transportation vehicle along various transportation routes—or artificial intelligence or algorithm for an autonomous vehicle that drives along such transportation routes—to pick up and drop off requesters.

As suggested above, the term “transportation requester” (or simply “requester”) refers to a person who submits a transportation request to a transportation matching system and/or who interacts with a requester device. For instance, a transportation requester includes a person who interacts with a requester device to send a transportation request to a transportation matching system. After the transportation matching system matches a requester with a provider, the requester can await pickup by the provider at a predetermined pickup location. Upon arrival of the provider, the requester can engage with the provider by getting into a transportation vehicle associated with the provider for transport to a drop-off location specified in the requester's transportation request. Accordingly, a requester may refer to (i) a person who requests a request or other form of transportation but who is still waiting for pickup or (ii) a person whom a transportation vehicle has picked up and who is currently riding within the transportation vehicle to a drop-off location.

Relatedly, the term “client device” refers to a computing device associated with (or used by) a provider or a requester. In some embodiments, a client device includes a provider device with a provider application comprising instructions that (upon execution) cause the provider device to perform various actions for a transportation matching system, as described herein. Such instructions may likewise cause a provider device to present a graphical user interface including a designated-location indicator within a digital map for navigating to a designated location at an intersection. Alternatively, a client device can refer to a requester device. In some embodiments, a requester device includes a requester application comprising instructions that (upon execution) cause the requester device to perform various actions for a transportation matching system, as described herein.

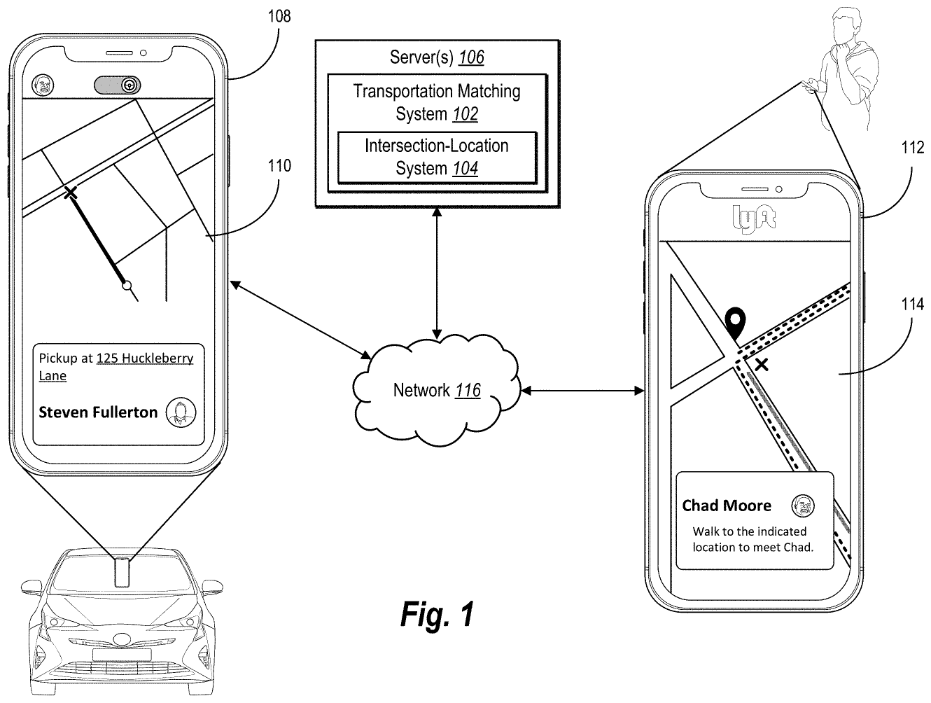

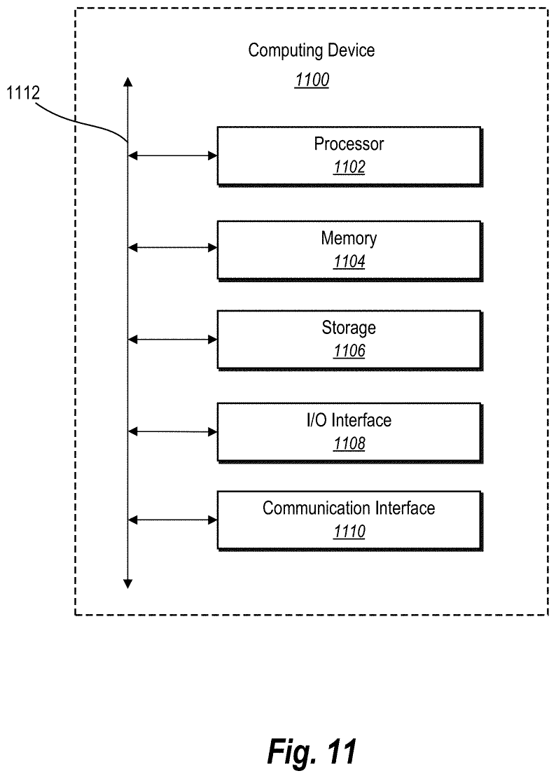

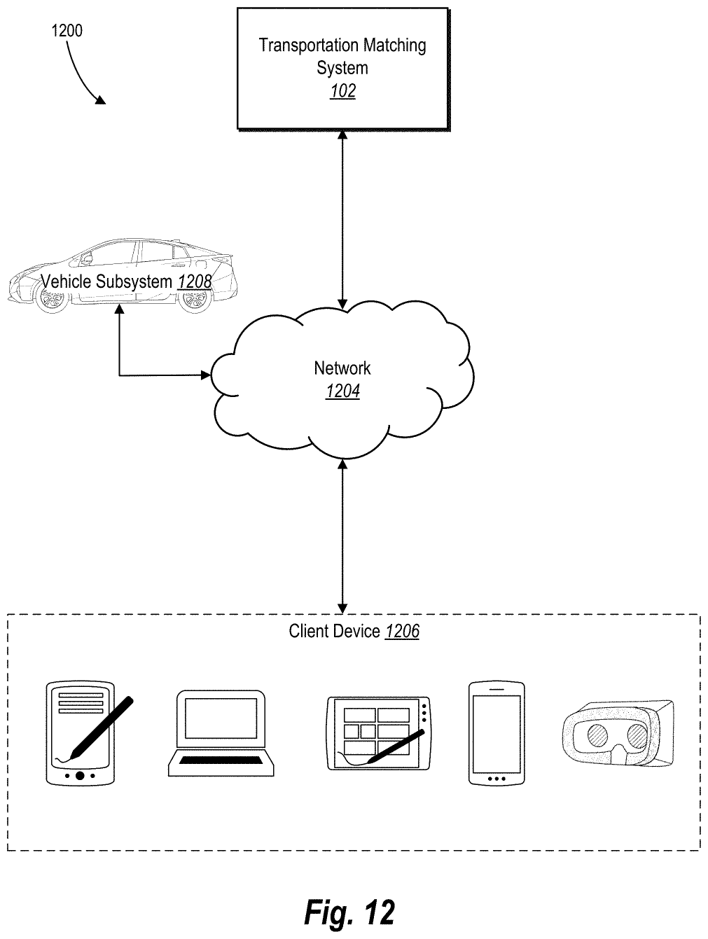

Additional detail regarding the intersection-location system will now be provided with reference to the figures. In particular, FIG. 1 illustrates a block diagram of a system environment for implementing an intersection-location system 104 in accordance with one or more embodiments. As shown in FIG. 1, the environment includes server(s) 106 housing the intersection-location system 104 as part of a transportation matching system 102. The environment of FIG. 1 further includes two client devices, a provider device 108 (including a provider application 110) and a requester device 112 (including a requester application 114), as well as a network 116. The server(s) 106 can include one or more computing devices to implement the intersection-location system 104. The provider device 108 may comprise any computing device as described in relation to FIGS. 11-12. Additional description regarding the illustrated computing devices (e.g., the server(s) 106, the provider device 108, and/or the requester device 112) is provided with respect to FIGS. 11-12 below.

As shown, the intersection-location system 104 utilizes the network 116 to communicate with the provider device 108 and the requester device 112. The network 116 may comprise any network described in relation to FIGS. 11-12. For example, the intersection-location system 104 communicates with the provider device 108 and the requester device 112 to match transportation requests received from the requester device 112 with the provider device 108. Indeed, the transportation matching system 102 or the intersection-location system 104 can receive a transportation request from the requester device 112 and can provide request information to the provider device 108, such as a requested location (e.g., a requested pickup location and/or a requested drop-off location), a requester identification (for a requester corresponding to the requester device 112), and a requested pickup time. In some embodiments, per device settings, the transportation matching system 102 or the intersection-location system 104 receives device information from the provider device 108 and the requester device 112, such as location coordinates (e.g., latitude, longitude, and/or elevation), orientations or directions, motion information, and indications of user interactions with various interface elements.

To facilitate connecting requests with transportation vehicles, in some embodiments, the transportation matching system 102 or the intersection-location system 104 communicates with the provider device 108 (e.g., through a provider application 110). As indicated by FIG. 1, the provider device 108 includes the provider application 110. In many embodiments, the transportation matching system 102 or the intersection-location system 104 communicates with the provider device 108 through the provider application 110 to, for example, receive and provide information including location data, motion data, transportation request information (e.g., pickup locations and/or drop-off locations), and transportation route information for navigating to one or more designated locations.

Similarly, the transportation matching system 102 or the intersection-location system 104 communicates with the requester device 112 (e.g., through the requester application 114) to facilitate connecting requests with transportation vehicles. In many embodiments, the intersection-location system 104 communicates with the requester device 112 through the requester application 114 to, for example, receive and provide information including location data, motion data, transportation request information (e.g., requested locations), and navigation information to guide a requester to a designated location.

As indicated above, the transportation matching system 102 or the intersection-location system 104 can provide (and/or cause the provider device 108 to display or render) visual elements within a graphical user interface associated with the provider application 110 and the requester application 114. For example, the transportation matching system 102 or the intersection-location system 104 can provide a digital map for display on the provider device 108 and that illustrates a transportation route to navigate to a designated location at an intersection. In addition, the intersection-location system 104 can provide a digital map for display on the requester device 112, where the digital map illustrates an initial transportation route (for a provider to navigate to the requested location) and a modified transportation route (for a provider to navigate to the designated location). The intersection-location system 104 selects the provider device 108 to service a transportation request received from the requester device 112 based on various factors. Such factors may include a requested location indicating a street intersection, candidate designated locations at the intersection, a provider-device location, locations of other provider devices, intersection-location attributes, provider incentives, requester incentives, a time of day, traffic information, and/or other transportation-matching considerations.

Although FIG. 1 illustrates the environment having a particular number and arrangement of components associated with the intersection-location system 104, in some embodiments, the environment may include more or fewer components with varying configurations. For example, in some embodiments, the transportation matching system 102 or the intersection-location system 104 can communicate directly with the provider device 108 and/or the requester device 112, bypassing the network 116. In these or other embodiments, the transportation matching system 102 or the intersection-location system 104 can be housed (entirely on in part) on the provider device 108 and/or the requester device 112. Additionally, the transportation matching system 102 or the intersection-location system 104 can include or communicate with a database for storing information, such as intersection-location attributes, provider-device location information, provider-device motion information, request information, and/or other information described herein.

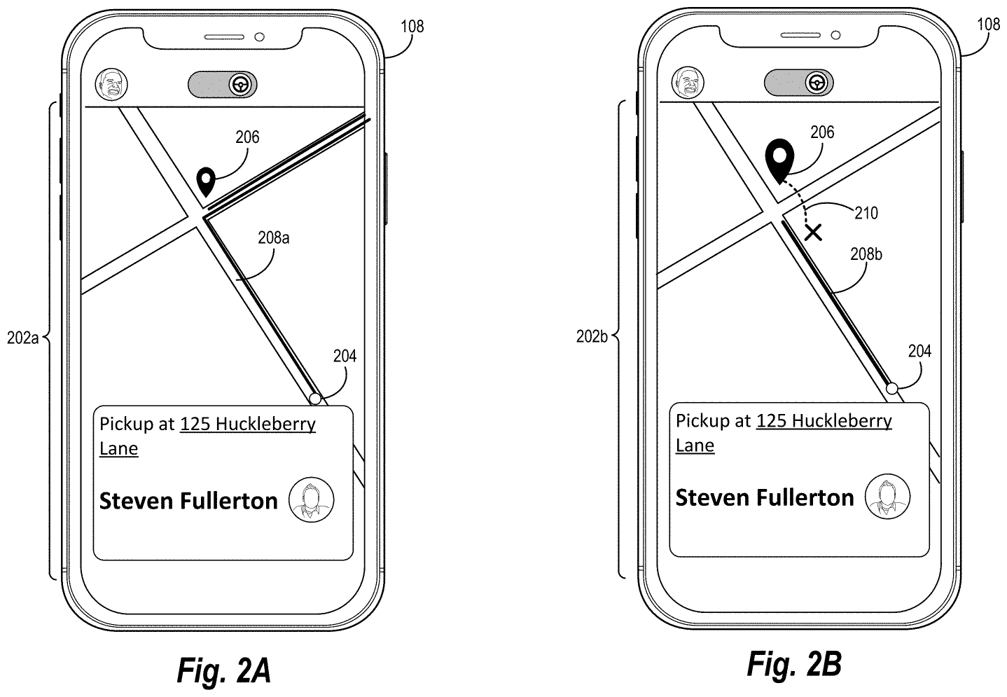

As mentioned, the intersection-location system 104 can select a designated location for a transportation request identifying a requested location associated with a street intersection. In some embodiments, the intersection-location system 104 can improve arrival time, reduce provider navigation, and simplify a transportation route by selecting a designated location from among candidate designated locations at the intersection. FIGS. 2A-2B illustrate the provider device 108 displaying different route segments for respective locations within a digital map in accordance with one or more embodiments. The descriptions of FIGS. 2A-2B provide an overview of the intersection-location system 104 and various improvements the intersection-location system 104 provides. Further detail regarding how the intersection-location system 104 selects designated locations to result in such improvements is provided below with reference to subsequent figures.

As illustrated in FIG. 2A, the provider device 108 displays a digital map 202a that includes a provider-location indicator 204, a requested-location indicator 206, and an initial route segment 208a. More specifically, the digital map 202a includes an initial route segment 208a that indicates a transportation route to navigate from the location of the provider device 108 (as indicated by the provider-location indicator 204) to the requested location (as indicated by the requested-location indicator 206). As shown, the transportation route for the initial route segment 208a is inefficient and includes multiple turns to navigate to the location corresponding to the requested-location indicator 206.

As illustrated in FIG. 2B, the provider device 108 displays a digital map 202b that includes the provider-location indicator 204, the requested-location indicator 206, and a modified route segment 208b. The modified route segment 208b indicates a transportation route for the provider to navigate from the provider location (as indicated by the provider-location indicator 204) to a designated location selected for the intersection associated with the requested location. As shown, compared to the initial route segment 208a, the transportation route for the modified route segment 208b is more efficient and includes fewer turns, requiring less navigation time and reducing the chance of making mistakes during navigation (e.g., the modified route segment 208b is straight).

The digital map 202b of FIG. 2B further includes a requester-navigation route 210. The requester-navigation route 210 indicates a path that the requester will walk (or otherwise navigate) to meet the provider at a designated location. For example, the intersection-location system 104 selects the designated location at a location other than the requested location and prompts the requester to walk a distance for a quicker arrival time and a more efficient transportation route. As illustrated in FIG. 2B, by selecting a designated location that prompts the requester to walk a short distance to meet the provider, the intersection-location system 104 improves the arrival time of the provider, reduces the likelihood of provider mistakes during navigation, provides a straighter modified route segment 208b, and reduces the likelihood of receiving a cancelation of the transportation request (or increases the likelihood of fulfilling the transportation request) as a result. In some embodiments, the provider device 108 displays the requester-navigation route 210, while in other embodiments, the provider device 108 does not display the requester-navigation route 210.

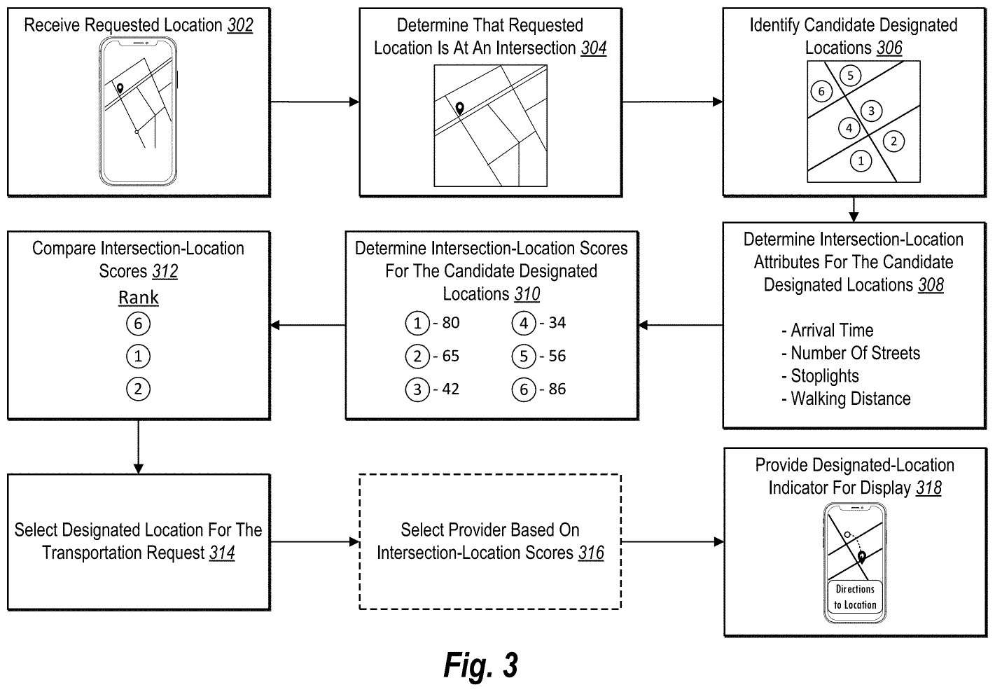

As mentioned, the intersection-location system 104 can determine a designated location to improve likelihood of fulfilling a transportation request that identifies a street intersection. In particular, the intersection-location system 104 can receive a transportation request that identifies a requested location associated with a street intersection and can determine a designated location for the transportation request. FIG. 3 illustrates an example sequence of acts 302-318 that the intersection-location system 104 performs as part of selecting and providing a designated location for a transportation request in accordance with one or more embodiments.

As illustrated in FIG. 3, the intersection-location system 104 performs an act 302 to receive a requested location. More specifically, the intersection-location system 104 receives a transportation request from the requester device 112 that identifies or indicates a requested location. In some cases, for instance, the intersection-location system 104 receives a transportation request that indicates a requested pickup location. In other cases, the intersection-location system 104 receives a transportation request that indicates a requested drop-off location. In one or more embodiments, the intersection-location system 104 receives a transportation request that indicates multiple requested locations (e.g., a requested pickup location, a waypoint location, and a requested drop-off location).

As further illustrated in FIG. 3, the intersection-location system 104 performs an act 304 to determine that the requested location is at an intersection. In particular, the intersection-location system 104 determines that the transportation request identifies a requested location associated with an intersection. For example, the intersection-location system 104 determines that the requested location is within a threshold distance of a street intersection. In some embodiments, the intersection-location system 104 determines midpoints of intersections and generates intersection boundaries that define geographic areas considered as part of the intersections. In other embodiments, the intersection-location system 104 determines corner points of intersections (e.g., vertices where the streets or the sidewalks adjacent to the streets meet) and generates intersection boundaries based on the corner points. For instance, the intersection-location system 104 generates a radius of a threshold distance from the midpoint (or a respective corner point along each street) of an intersection and identifies the area within the radius as part of the intersection. Alternatively, the intersection-location system 104 identifies an area (regular or irregular in shape) defined by a threshold distance from the midpoint and extending outward along each street that intersects to form the intersection.

Based on determining that the requested location is within a threshold distance of an intersection, the intersection-location system 104 further performs an act 306 to identify candidate designated locations. More specifically, the intersection-location system 104 determines candidate designated locations at the intersection associated with the transportation request. For example, the intersection-location system 104 identifies candidate designated locations within a threshold distance of (a midpoint or a corner point of) the street intersection. In some embodiments, the intersection-location system accesses digital maps of intersections (e.g., from a commercially available mapping service) to identify candidate designated locations. For instance, the intersection-location system accesses digital maps that indicate historical transportation data for previous transportation events at intersections and/or that reflect stored intersection templates.

To identify the candidate designated locations, in some embodiments, the intersection-location system 104 accesses historical transportation data. In particular, the intersection-location system 104 accesses historical transportation data that indicates previous event locations for transportation events associated with previous transportation requests. For example, the intersection-location system 104 determines an event type (e.g., pickup or drop-off) associated with the received request location and identifies previous event locations of the same event type that have occurred at (e.g., within a threshold distance of) the intersection. In some embodiments, the intersection-location system 104 selects candidate designated locations from among the previous event locations. For instance, the intersection-location system 104 selects as candidate designated locations those previous event locations where at least a threshold number of previous events have been performed. In some cases, the intersection-location system 104 selects those previous event locations that have occurred most recently, that have occurred at a similar time of day as the received request, that have occurred in similar weather conditions as the received request, that have occurred under similar traffic conditions as the received request, and/or that have occurred under similar road conditions (e.g., based on road construction) as the received request.

In one or more embodiments, the intersection-location system 104 accesses stored intersection templates to identify candidate designated locations (e.g., from a digital map). In particular, the intersection-location system 104 generates and stores intersection templates for every street intersection (or a subset of intersections). Within the intersection templates, the intersection-location system 104 includes placements for candidate designated locations. For example, the intersection-location system 104 receives indications from annotators or labelers that place candidate designated locations at particular locations for intersections. As another example, the intersection-location system 104 automatically (e.g., without user input) identifies candidate designated locations for an intersection based on the layout of the intersection (e.g., from a digital mapping system).

Indeed, in some embodiments, the intersection-location system 104 identifies candidate designated locations by analyzing the intersection itself (e.g., to include within an intersection template or for execution at runtime). To elaborate, the intersection-location system 104 identifies a number of sidewalk corners that are part of (or within a threshold distance of) an intersection. For example, the intersection-location system 104 identifies sidewalks that run parallel to streets and identifies locations where the sidewalks of intersecting streets meet to form sidewalk corners. The intersection-location system 104 places a candidate designated location on different sides of a sidewalk at a sidewalk corner. Thus, for an intersection with two streets intersecting each other, the intersection-location system 104 identifies eight candidate designated locations, two for each sidewalk corner associated with the intersection.

As further illustrated in FIG. 3, the intersection-location system 104 performs an act 308 to determine intersection-location attributes for the candidate designated locations of an intersection. In some embodiments, the intersection-location system 104 determines intersection-location attributes for each candidate designated location. For example, the intersection-location system 104 determines an intersection-location attribute, such as a predicted arrival time for a provider or a transportation vehicle to arrive at a candidate designated location. For a given candidate designated location, the intersection-location system 104 determines a number of intersection-location attributes for comparison, such as a plurality of different predicted arrival times for different providers to arrive at a particular candidate designated location.

The intersection-location system 104 determines other intersection-location attributes that impact an effectiveness, an efficiency, or a practicality of selecting a candidate designated location as well. For example, the intersection-location system 104 determines a walking distance for a requester (e.g., associated with the requester device 112) to arrive at the candidate designated location. In some embodiments, the intersection-location system 104 determines a walking distance from a current location of the requester device 112. In these same or other embodiments, the intersection-location system 104 determines a walking distance from a requested location submitted with a transportation request.

When determining intersection-location attributes, in some cases, the intersection-location system 104 determines a likelihood that the transportation vehicle or the provider will have to move from the candidate designated location before the requester arrives at the candidate designated location. To elaborate, the intersection-location system 104 identifies locations such as timed parking zones, no loading zones, school zones, constructions zones, specialized vehicle parking zones, or other areas that would prohibit a provider from stopping at the candidate designated location (either at all or for a threshold period of time). In some embodiments, the intersection-location system 104 determines this likelihood by accessing historical transportation data that indicates previous instances where providers have been unable to stop at, or have moved from, the candidate designated location before a requester arrived at the candidate designated location.

As another intersection-location attribute, in some embodiments, the intersection-location system 104 determines a likelihood that the provider or the transportation vehicle will make a wrong turn while navigating to the candidate designated location. Specifically, the intersection-location system 104 determines a transportation route to guide a provider to the candidate designated location and a likelihood that the provider will navigate the route incorrectly. In one or more embodiments, the intersection-location system 104 accesses historical transportation data that indicates wrong turns made by providers while navigating the same transportation route. In some cases, the intersection-location system 104 accesses historical transportation data that indicates wrong turns made by providers while navigating from locations similar to (e.g., within a threshold distance of) a location of the provider device 108 to locations similar to (e.g., within a threshold distance of) the candidate designated location.

Additionally or alternatively, the intersection-location system 104 determines a complexity rating for the transportation route. For instance, the intersection-location system 104 determines higher complexity ratings for transportation routes with more turns. In some embodiments, the intersection-location system 104 identifies left turns as more complex than right turns, and u-turns as even more complex than left turns. Based on the number of turns, the types and complexity of turns, and the distance of a transportation route, the intersection-location system 104 determines a complexity rating for the transportation route that indicates (e.g., is directly proportional to) a likelihood that a provider will make a wrong turn while navigating to the candidate designated location. In some cases, the intersection-location system 104 thus avoids excessive left turns or u-turns on the part of a provider.

Further, in some cases, the intersection-location system 104 determines an intersection-location attribute in the form of a number of streets for the requester to cross to arrive at the candidate designated location. In particular, the intersection-location system 104 identifies a location of the requester device 112 and determines a number of streets between the requester location and the candidate designated location. In some cases, prompting a requester to cross across more streets makes cancelation of the transportation request more likely and fulfillment of the request less likely.

As an additional intersection-location attribute, in some embodiments, the intersection-location system 104 determines widths of one or more streets for the requester to cross to arrive at the candidate designated location. Particularly, in addition to the number of streets for a requester to cross, the intersection-location system 104 can determine widths of the streets as well. For example, the intersection-location system 104 determines a width of a street or a distance of walking across a crosswalk on the street. In some cases, prompting a requester to walk across wider streets (which are generally streets with more lanes and more traffic) increases a likelihood of cancelation and decreases a likelihood of fulfillment. Indeed, in some embodiments, the intersection-location system 104 determines (as an intersection-location attribute) a number of lanes on streets for the requester to cross to arrive at the candidate designated location.

Additionally, in some embodiments, the intersection-location system 104 determines an intersection-location attribute in the form of a number of medians for the requester to cross to arrive at the candidate designated location. More specifically, the intersection-location system 104 identifies medians (or guardrails or other barriers) located within or along streets between a location of the requester device 112 and the candidate designated location. In some cases, prompting a requester to cross a median or a guardrail to arrive at a candidate designated location eliminates the candidate designated location from consideration. In other cases, prompting such navigation increases the likelihood of cancelation and decreases the likelihood of fulfillment of the transportation request.

As another intersection-location attribute, in some embodiments, the intersection-location system 104 determines a number of train tracks for the requester to cross to arrive at the candidate designated location. In particular, the intersection-location system 104 identifies any train tracks (or light rail tracks or subway tracks or other tracks) that run between a location of the requester device 112 and the candidate designated location. In some cases, prompting a requester to cross a train track increases a likelihood of cancelation and decreases a likelihood of fulfillment for a transportation request.

Additionally, in some embodiments, the intersection-location system 104 determines (as an intersection-location attribute) a number of stop lights for the requester to navigate to arrive at the candidate designated location. Particularly, the intersection-location system 104 identifies stop lights at streets of a street intersection that may include crosswalks. In some embodiments, the intersection-location system 104 determines or estimates a timing of the stop lights and/or a time to cross the crosswalks (e.g., using an average or predetermined time for crossing streets with stop lights or crosswalks). In some cases, prompting a requester to navigate a stoplight increases a likelihood of cancelation and decreases a likelihood of fulfillment of a transportation request. Likewise, prompting a requester to navigate stoplights can, due to the increased time and effort required, increase a likelihood of cancelation and can decrease a likelihood of fulfillment (because of delays resulting from waiting for the stoplights).

Further still, in certain implementations, the intersection-location system 104 determines (as an intersection-location attribute) an indication of whether the provider or the transportation vehicle will pass by the requester while navigating to the candidate designated location. To elaborate, the intersection-location system 104 determines a transportation route from a location of the provider device 108 to the candidate designated location. In addition, the intersection-location system 104 determines whether the transportation route will pass by a location of the requester device 112 while the provider and/or the requester navigate to the candidate designated location. In some cases, when a requester can see a provider pass them by while navigating to a pickup location, a requester is more likely to cancel a transportation request.

In addition, in certain implementations, the intersection-location system 104 determines (as an intersection-location attribute) a predicted straightness for a route segment associated with a transportation route including the candidate designated location. More particularly, the intersection-location system 104 determines a transportation route from a location of the provider device 108 to the candidate designated location. Based on the transportation route, the intersection-location system 104 determines a straightness of a route segment of the transportation route from a current (or near-current) location of the provider device 108 or from an entrance location along a street leading into the street intersection. In some cases, the intersection-location system 104 determines a straightness of such a route segment based on the route segment depicted within a digital map of the street intersection within a graphical user interface (e.g., on the provider device 108 and/or the requester device 112). The intersection-location system 104 determines a higher degree of straightness for a route segment that depicts fewer turns and/or less drastic turns. Conversely, the intersection-location system 104 determines a lower degree of straightness for a route segment that depicts more turns and/or more drastic turns. In some cases, providing a straighter route segment (e.g., as displayed on a requester device) decreases a likelihood of cancelation and increases a likelihood of fulfillment of a transportation request.

In addition (or alternatively) to determining a predicted straightness of a route segment for a transportation route from a location of the provider device 108 to the candidate designated location, in some embodiments, the intersection-location system 104 further determines a predicted straightness of a transportation route associated with the transportation request. In particular, the intersection-location system 104 determines a transportation route for fulfilling the transportation request (e.g., by picking up and dropping off the requester) based on either picking up or dropping off the requester at the candidate designated location. The intersection-location system 104 further determines a predicted straightness for the transportation route for fulfilling the transportation request.

As further illustrated in FIG. 3, the intersection-location system 104 performs an act 310 to determine intersection-location scores for the candidate designated locations—based on intersection-location attributes. In particular, the intersection-location system 104 determines intersection-location scores for each respective candidate designated location (e.g., the candidate designated locations 1-6) based on their respective intersection-location attributes. For instance, the intersection-location system 104 determines intersection-location scores which indicate relative improvements of one candidate designated location over another. In some embodiments, intersection-location scores indicate or correspond to objectives of an object function. For example, an intersection-location score can indicate or correspond to conversion probability (e.g., a likelihood of fulfillment) for a transportation request that includes a particular candidate designated location. As another example, an intersection-location score can indicate or correspond to an expected fulfillment value for a transportation request. Additional detail regarding intersection-location scores and an object function is provided below.

In one or more embodiments, the intersection-location system 104 determines intersection-location scores based on an event type of a transportation event. To elaborate, in some cases, for a given candidate designated location, the intersection-location system 104 determines a different intersection-location score for a pickup event than for a drop-off event. Indeed, some candidate designated locations may be better suited for pickup than for drop-off (or vice-versa) due to traffic flow, available parking, and other factors. Thus, for a transportation request indicating a requested pickup location, the intersection-location system 104 can determine a first intersection-location score for a given candidate designated location. For a second transportation request indicating a requested drop-off location at the same intersection, the intersection-location system 104 can determine a second intersection-location score for the same candidate designated location. Based on different event types, the intersection-location system 104 can determine different weights to apply to the different intersection-location attributes in determining intersection-location scores.

In addition (or alternatively) to transportation event types, in certain implementations, the intersection-location system 104 determines intersection-location scores based on requester events and/or requester indicators. More specifically, the intersection-location system 104 accesses, in accordance with privacy settings and governing privacy regulations, prior requester events, such as prior pickup locations and/or prior drop-off locations at an intersection. Thus, the intersection-location system 104 determines higher intersection-location scores for candidate designated locations associated with requester-specific prior event locations (e.g., for pickup or drop-off, respectively). As another example, and in accordance with opt-in privacy settings, the intersection-location system 104 determines intersection-location scores for candidate designated locations based on an indication of a disability associated with a requester. For instance, the intersection-location system 104 generates a lower intersection-location score for (or removes from consideration) a candidate designated location that is across a street from a requester with a disability that makes walking or navigating across streets more difficult.

In one or more embodiments, the intersection-location system 104 determines intersection-location scores based on a request type of a transportation request. In particular, the intersection-location system 104 determines a request type for a transportation request, such as a shared transportation request for multiple requesters to ride in the same transportation vehicle to respective locations. Based on different request types, the intersection-location system 104 determines different weights to apply to different intersection-location attributes in generating intersection-location scores. For a shared transportation request, for example, the intersection-location system 104 determines a heavy weight to apply to a predicted straightness for a route segment of a transportation route. Indeed, shared rides often rely on relatively straight route segments from location to location, so that a provider can pick up and drop off requesters with minimal deviation or back-tracking. Thus, in some embodiments, the intersection-location system 104 places a heavy emphasis on the predicted straightness of a route segment (e.g., by applying a weight) in determining intersection-location scores for candidate designated locations.

In one or more embodiments, the intersection-location system 104 considers only a subset of intersection-location attributes—or weights certain intersection-location attributes more highly—in determining intersection-location scores. For example, in some cases, the intersection-location system 104 determines intersection-location scores based solely on predicted arrival time. Indeed, predicted arrival time is often the most important factor for a requester when submitting a transportation request because the requester wants prompt pickup and/or prompt drop-off. Thus, the intersection-location system 104 determines intersection-location scores for candidate designated locations considering only how the candidate designated locations affect the predicted arrival times of various providers.

In one or more embodiments, the intersection-location system 104 utilizes an intersection-location machine learning model as part of generating intersection-location scores. For example, the intersection-location system 104 utilizes an intersection-location machine learning model to generate or determine likelihoods of fulfillment (e.g., conversion probabilities) for a transportation request based on different candidate designated locations associated with respective intersection-location attributes. In some cases, the intersection-location system 104 determines a higher conversion probability for a transportation request including a first candidate designated location than for the transportation request including a second candidate designated location. Additional detail regarding the intersection-location machine learning model is provided below with reference to subsequent figures.

As further illustrated in FIG. 3, the intersection-location system 104 performs an act 312 to compare intersection-location scores. In particular, the intersection-location system 104 compares intersection-location scores for different candidate designated locations at an intersection to determine which intersection-location scores are higher and which are lower relative to one another. As shown in FIG. 3, the intersection-location system 104 compares the intersection-location scores to rank the candidate designated locations, ranking location 6 as the highest-ranked candidate designated location (with a score of 86), followed by location 1 (with a score of 80) and location 2 (with a score of 65). In some embodiments, the intersection-location system 104 ranks candidate designated locations by expected fulfillment values or by conversion probabilities. Indeed, as explained in further detail with reference to the objective function below, the intersection-location system 104 determines conversion probabilities and expected fulfillment values for transportation requests.

As further shown in FIG. 3, the intersection-location system 104 performs an act 314 to select a designated location for the transportation request. In particular, the intersection-location system 104 selects a designated location from among the candidate designated locations at the intersection. For example, the intersection-location system 104 selects the designated location based on the intersection-location scores (e.g., based on the comparison or the ranking of the intersection-location scores). As another example, the intersection-location system 104 selects the designated location based on an objective function for increasing conversion probabilities and/or expected fulfillment values. In some embodiments, the intersection-location system 104 selects a highest-ranked candidate designated location, or a candidate designated location with a highest intersection-location score, as the designated location. In certain implementations, the intersection-location system 104 automatically selects a designated location from a pool of candidate designated locations without user input.

In some embodiments, the intersection-location system 104 determines a maximum walking distance for a requester to navigate to a candidate designated location without the requester opting in to traveling to selected designated location. For example, the intersection-location system 104 eliminates from consideration any candidate designated locations that require a requester to walk farther than a threshold distance. In some cases, the intersection-location system 104 provides an option (e.g., a user-selectable opt-in element within a graphical user interface) for a requester to opt in to longer walking distances. Based on receiving a user selection of the opt-in element, the intersection-location system 104 considers candidate designated locations that require walking distances farther than the initial threshold distance.

In some embodiments, the intersection-location system 104 selects a designated location for a transportation request (or multiple designated locations for multiple transportation requests) in accordance with an objective function. Indeed, the intersection-location system 104 utilizes an objective function to determine which candidate designated locations to select for which transportation requests. For instance, the intersection-location system 104 utilizes the intersection-location scores of the candidate designated locations to inform the objective function. In one or more embodiments, the intersection-location system 104 utilizes intersection-location scores to represent conversion probabilities (e.g., likelihoods of fulfillment) for transportation requests.

As a result, in certain implementations, the intersection-location system 104 utilizes an objective function to identify which candidate designated locations (and which candidate providers) to select for which transportation requests. Indeed, based on intersection-location scores, the intersection-location system 104 selects designated locations (and providers) that accomplish one or more objectives of an objective function, as given by:

$${\sum }_{match options}^{ } 𝔼 [ fulfillment \_ {value}_{i} ] = {\sum }_{match options}^{ } ( ℙ ( {conversion}_{i} ) \times ( fulfillment \_ {value}_{i} + {θ}_{i} ) )$$

where [symbol] (conversionᵢ) represents a conversion probability for a transportation request i, fulfillment_valueᵢ represents a value earned if a transportation request converts or is fulfilled, match options represents possible combinations of candidate designated locations and providers or transportation vehicles, and/or requesters for a given geographic area and time period, and θᵢ represents an incremental-transportation value (or a long-term value) associated with converting or fulfilling the transportation request i. Using θ allows the intersection-location system 104 to balance a tradeoff between objectives such as fulfillment value and request fulfillment or conversion (e.g., a larger θ corresponds to focusing more on conversions/fulfillments).

Utilizing the objective function, the intersection-location system 104 determines expected fulfillment values based on conversion probabilities and fulfillment values for requesters being transported by various transportation vehicles to or from particular candidate designated locations in fulfillment of transportation requests. Indeed, in some embodiments, the intersection-location system 104 generates expected fulfillment values across different combinations of transportation vehicles, requesters, and candidate designated locations utilizing an objective function based on the conversion probabilities and fulfillment values.

As the objective function suggests, in some embodiments, the intersection-location system 104 determines and sums expected fulfillment values across different combinations (or match options) of providers or transportation vehicles, requesters, and candidate designated locations for a particular geographic region and time period. For a given combination of a provider or a transportation vehicle, a requester, and candidate designated location, for instance, the intersection-location system 104 determines a conversion probability [symbol] (conversionᵢ) that the provider or the transportation vehicle will transport the requester to a drop-off location based on an initial or subsequent transportation request during a particular time period using the candidate designated location (e.g., as a pickup, drop-off, or waypoint location). Similarly, for a given combination of a provider or a transportation vehicle, a requester, and candidate designated location, the intersection-location system 104 determines fulfillment_valueᵢ for the provider or the transportation vehicle transporting the requester to a drop-off location based on an initial or subsequent transportation request during a particular time period using the candidate designated location (e.g., as a pickup, drop-off, or waypoint location).

From the [symbol] (conversionᵢ) and the fulfillment_valueᵢ, the intersection-location system 104 determines the [symbol] [fulfillment_valueᵢ]. Indeed, in some embodiments, the intersection-location system 104 combines (e.g., determines a product of) the [symbol] (conversionᵢ) and the fulfillment_valueᵢ to determine an expected fulfillment value for a particular match option (e.g., a particular combination of a provider and a candidate designated location). Additionally, the intersection-location system 104 sums the expected fulfillment values across all (or a number of) match options across for the given intersection to determine the expected fulfillment value IE [symbol] [fulfillment_valueᵢ] for the transportation request i. In some embodiments, the intersection-location system 104 determines the expected fulfillment value in a system-wide (or a region-wide) sense by combining expected fulfillment values for only those match options (e.g., combinations of requesters, providers, and candidate designated locations) that result in the highest total expected fulfillment value for system (or region).

As just mentioned, and as shown in FIG. 3, the intersection-location system 104 performs an act 316 to select a provider based on the intersection-location scores. In particular, the intersection-location system 104 selects a provider to fulfill the transportation request (or multiple providers to fulfill multiple transportation requests) in accordance with the objective function. For instance, the intersection-location system 104 selects a provider to fulfill a transportation request based on a set of match options (e.g., combinations of providers, requesters, and candidate designated locations) that results in a largest expected fulfillment value for a geographic region within a particular time period. A provider fulfills a transportation request by navigating to the designated location to perform a transportation event, such as a pickup or a drop-off In determining intersection-location attributes, as described above, the intersection-location system 104 analyzes multiple candidate providers for each candidate designated location. Indeed, the intersection-location system 104 compares candidate providers to determine predicted arrival times to the various candidate designated locations, numbers of turns to navigate to the candidate designated locations, predicted straightness of respective route segments for navigating to the candidate designated locations, and so forth.

Thus, in some cases, the intersection-location attributes and the corresponding intersection-location scores encapsulate or represent measures of effectiveness (or likelihoods of fulfillment) resulting from selecting not just a candidate designated location, but a combination of a candidate designated location, a candidate provider, and a requester. Indeed, the intersection-location system 104 compares match options (as mentioned above with reference to the objective function) that represent provider-location-requester trios of candidate providers, candidate designated locations, and requesters (e.g., on a system-wide or a region-wide basis). As a result, in some embodiments, the objective function described herein accomplishes an objective such as increasing conversion probability and/or increasing expected fulfillment value based on selecting trios of candidate providers to navigate to candidate designated locations to service particular requesters (e.g., as represented by the “match options” above).

As further illustrated in FIG. 3, the intersection-location system 104 performs an act 318 to provide a designated-location indicator for display. In particular, the intersection-location system 104 provides the designated-location indicator for display on a client device such as the provider device 108 and/or the requester device 112. For example, the intersection-location system 104 provides a designated-location indicator that indicates the designated location that is selected for the transportation request. In some embodiments, the intersection-location system 104 provides the designated-location indicator for display within a digital map presented on a client device.

In addition to a designated-location indicator, in certain implementations, the intersection-location system 104 provides or displays other graphical interface elements as well. For example, in some embodiments, the intersection-location system 104 provides navigational directions to guide a requester and/or a provider to the designated location. In addition (or alternatively), the intersection-location system 104 provides a visual comparison of an initial route segment and a modified route segment. For instance, the intersection-location system 104 provides, for simultaneous display together in a single digital map, an initial route segment that indicates a transportation route for navigating to the requested location and a modified route segment that indicates a transportation route for navigating to the designated location (which location is different from, and improves upon, the requested location). Additional detail regarding graphical user interfaces associated with intersection locations is provided below with reference to subsequent figures.

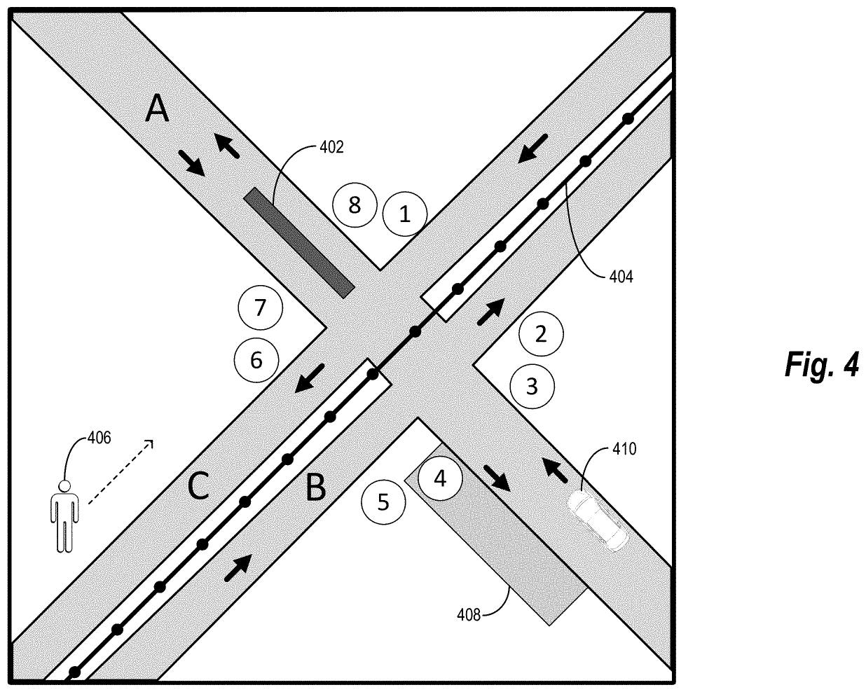

As mentioned above, the intersection-location system 104 can determine intersection-location attributes for various candidate designated locations associated with an intersection. In particular, the intersection-location system 104 can determine different intersection-location attributes for various combinations of trios of candidate designated locations, candidate providers, and requesters. FIG. 4 illustrates an example intersection including candidate designated locations and various elements that impact the determination of intersection-location attributes in accordance with one or more embodiments.

As illustrated in FIG. 4, the intersection-location system 104 identifies a pool of eight candidate designated locations for the depicted intersection. In particular, the intersection-location system 104 identifies eight possible candidate designated locations that are within a threshold distance of (the midpoint or one or more corner points of) the intersection. In addition, the intersection-location system 104 determines intersection-location attributes for the candidate designated locations based on medians, train tracks, specialized zones, traffic flow, walking distance, and other factors. Further, the intersection-location system 104 determines the intersection-location attributes for the candidate designated locations based on the location of the requester 406 (or the requester device 112) and the location of the transportation vehicle 410 (or the provider device 108).

For example, the intersection-location system 104 determines intersection-location attributes for the candidate designated location “1.” For the candidate designated location “1,” the intersection-location system 104 determines a walking distance from the location of the requester 406 to the candidate designated location “1.” In addition, the intersection-location system 104 determines that the requester 406 will have to cross street A, which includes the median 402 and which has a particular width (and perhaps a stoplight). Further, the intersection-location system 104 determines that the transportation vehicle 410 will have to make a right turn from street A to street B, then make a u-turn (or otherwise navigate back) onto street C to arrive at the candidate designated location “1” while facing in the direction of traffic (as indicated by the arrows on the streets). The intersection-location system 104 further determines a likelihood that that provider will make a wrong turn while navigating to the candidate designated location “1” as well as a predicted straightness of a route segment for a transportation route including the candidate designated location “1.”

For the candidate designated location “2,” the intersection-location system 104 determines different intersection-location attributes than for the candidate designated location “1.” In particular, the intersection-location system 104 determines a walking distance for the requester 406 to arrive at the candidate designated location “2.” In addition, the intersection-location system 104 determines that the requester 406 has to cross streets A, B, and C (which have respective widths and may or may not have stoplights) to arrive at the candidate designated location “2.” Further, the intersection-location system 104 determines that the requester has to cross the train track 404 to arrive at the candidate designated location “2.” Additionally, the intersection-location system 104 determines that the transportation vehicle 410 needs to turn from street A onto street B to arrive at the candidate designated location “2.” The intersection-location system 104 further determines a likelihood of a wrong turn as well as a predicted straightness for a transportation route including the candidate designated location “2.”

As further suggested by FIG. 4, the intersection-location system 104 determines intersection-location attributes for the candidate designated location “3.” More specifically, the intersection-location system 104 determines that the requester has to cross streets A, B, and C, as well as the train track 404 to arrive at the candidate designated location “3” (much like arriving at the candidate designated location “2”). The intersection-location system 104 also determines that the transportation vehicle 410 needs no turns to access the candidate designated location “3.” In addition, the intersection-location system 104 determines a likelihood that the transportation vehicle 410 will make a wrong turn and further determines a predicted straightness for a route segment that includes the candidate designated location “3.”

For the candidate designated location “4,” the intersection-location system 104 determines that the requester 406 needs to cross streets C and B as well as the train track 404. In addition, the intersection-location system 104 determines a walking distance for the requester 406 to arrive at the candidate designated location “4.” Further, the intersection-location system 104 determines a likelihood that the transportation vehicle 410 will make a wrong turn while navigating to the candidate designated location “4” based on a transportation route for the transportation vehicle 410 to arrive at the candidate designated location “4” while facing the direction of traffic (e.g., by making a u-turn on street A or several other turns). Additionally, the intersection-location system 104 determines a predicted straightness of a route segment for a transportation route that includes the candidate designated location “4.”

In some cases, the intersection-location system 104 determines whether or not (or a likelihood that) the transportation vehicle 410 will pass by the requester 406 while the transportation vehicle 410 and/or the requester 406 is navigating to the candidate designated location “4.” For instance, the intersection-location system 104 determines a likelihood that the transportation vehicle 410 will pass the requester 406 while driving along street A while the requester is crossing streets B and/or C. Additionally (or alternatively), the intersection-location system 104 determines a likelihood that the transportation vehicle 410 will pass by the initial requested location submitted by the requester 406. In some cases, the requester 406 may become frustrated if the transportation vehicle 410 passes them (or the initial requested location) while navigating to a designated location, increasing a likelihood of cancelation.

In addition, the intersection-location system 104 determines a likelihood that the transportation vehicle 410 will have to move from the candidate designated location “4” before the requester 406 arrives. In some cases, such a likelihood depends on a location of a specialized zone 408 depicted in FIG. 4. The specialized zone 408 may be, for example, a no loading zone, a specialized vehicle parking zone, a school zone, or a construction zone. In some cases, the intersection-location system 104 identifies the specialized zone 408 that includes the candidate designated location “4” and which impacts a time that the transportation vehicle 410 can stop to wait for the requester 406. The specialized zone 408 impacts the likelihood that the transportation vehicle 410 will have to move from the candidate designated location “4” because the transportation vehicle 410 will likely be unable to stop and park in such a location, at least for any extended period to wait for a requester to arrive. Other factors that impact the likelihood that the transportation vehicle 410 will have to move before the requester arrives include traffic conditions (e.g., heavy traffic may result in other drivers honking and forcing the transportation vehicle 410 out of a certain location) and time of day (e.g., school zones are crowded or even off limits when school is starting or gets out for the day).

Additionally, the intersection-location system 104 determines intersection-location attributes for the candidate designated locations “5,” “6,” “7,” and “8.” In particular, the intersection-location system 104 determines respective walking distances for the requester 406, street crossing, train track crossings, median crossings, turns for the transportation vehicle 410, and route segments. The intersection-location system 104 thus determines different intersection-location attributes for each of the candidate designated locations “1” through “8.” Based on the intersection-location attributes, the intersection-location system 104 further determines intersection-location scores (e.g., that indicate conversion probabilities) or other objective-function inputs and selects a candidate designated location as a designated location for a transportation request received from the requester 406 (e.g., via the requester device 112).

In some embodiments, the intersection-location system 104 eliminates certain candidate designated locations from consideration. For example, the intersection-location system 104 identifies candidate designated locations that are placed along larger, busier streets and/or streets where stopping is illegal or impractical. In some cases, the intersection-location system 104 eliminates candidate designated locations “3,” “4,” “7,” and “8” because they are located along street A, which may be too busy for stopping to perform any transportation events. In one or more embodiments, the intersection-location system 104 eliminates candidate designated locations that require the requester to cross one or more streets and/or that require the requester to cross a median or train tracks.

In one or more embodiments, the intersection-location system 104 considers only candidate designated locations that are egress locations, as opposed to ingress locations. An egress location refers to a location where the transportation vehicle 410 would be leaving an intersection in route to a drop-off location associated with a transportation request. An ingress location, on the other hand, refers to a location where the transportation vehicle 410 would be entering the intersection in route to pick up or drop off a requester at a designated location. Indeed, in some cases, the intersection-location system 104 determines intersection-location scores for the candidate designated locations “2,” “4,” “6,” and “8” as egress locations and removes from consideration the candidate designated locations “1,” “3,” “5,” and “7” as ingress locations. Conversely, in some cases, the intersection-location system 104 determines intersection-location scores for the candidate designated locations “1,” “3,” “5,” and “7” as ingress locations and removes from consideration candidate designated locations “2,” “4,” “6,” and “8” as egress locations.

To elaborate, in some embodiments, the intersection-location system 104 identifies a candidate designated location as an ingress location if it is on the side of an intersection where the transportation vehicle 410 will enter the intersection to perform a transportation event, such as a pickup or a drop-off event. The intersection-location system 104 identifies a candidate designated location as an egress location if it is on the side of the intersection where the transportation vehicle 410 will exit the intersection while navigating to a location where the transportation vehicle 410 will perform a subsequent transportation event (e.g., a drop-off or a subsequent pickup event). As illustrated in FIG. 4, and assuming that the transportation vehicle 410 will proceed out of the intersection in the down-left direction along street C, the intersection-location system 104 identifies the candidate designated location “3” as an ingress location and the candidate designated location “6” as an egress location. In some cases, the intersection-location system 104 thus determines a lower intersection-location score (or removes from consideration) the candidate designated location “3” and determines a higher intersection-location score for the candidate designated location “6.”

While the description of FIG. 4 refers to particular intersection-location attributes, the intersection-location system 104 can determine additional or alternative intersection-location attributes for one or more of the depicted candidate designated locations. Additionally, the intersection-location system 104 can determine more or fewer candidate designated locations for an intersection and/or can place the candidate designated locations at additional or alternative locations. Further, the intersection-location system 104 can determine intersection-location attributes associated with multiple transportation vehicles or providers, rather than the single transportation vehicle 410.

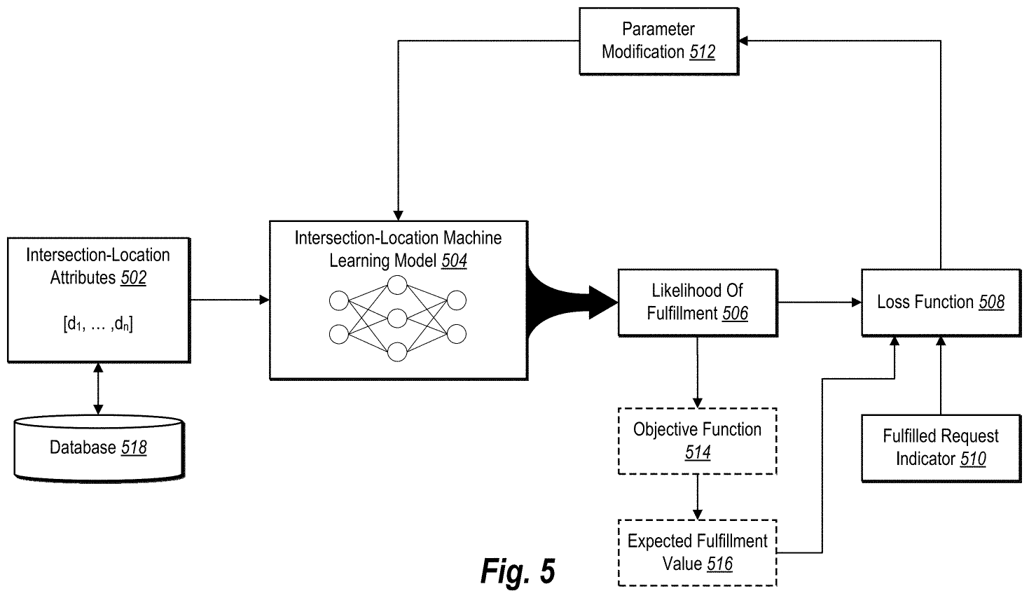

As mentioned above, the intersection-location system 104 can utilize an intersection-location machine learning model to determine conversion probabilities or likelihoods of fulfillment for transportation requests based on various candidate designated locations at intersections. In some embodiments, the intersection-location system 104 can utilize an intersection-location machine learning model as part of an objective function for increasing conversions/fulfillments and/or increasing expected fulfillment value. FIG. 5 illustrates an example flow for implementing and/or training an intersection-location machine learning model in accordance with one or more embodiments.

As illustrated in FIG. 5, the intersection-location system 104 identifies or determines intersection-location attributes 502. In particular, for a given candidate designated location (or a selected designated location), the intersection-location system 104 generates a vector of intersection-location attributes 502 by, for example, using an encoder neural network to extract a feature vector from a set of intersection-location attributes 502. In some embodiments, the intersection-location system 104 accesses the intersection-location attributes 502 for a candidate designated location from a database 518 which stores intersection-location attributes for multiple candidate designated locations.

As further shown in FIG. 5, the intersection-location system 104 inputs the intersection-location attributes 502 (or the feature vector of intersection-location attributes 502) into the intersection-location machine learning model 504. The intersection-location machine learning model 504 analyzes the intersection-location attributes 502 (e.g., by passing information between neurons and layers of a neural network architecture) to generate an output in the form of a likelihood of fulfillment 506 (or a conversion probability) for a transportation request. Thus, the intersection-location machine learning model 504 determines, generates, or predicts a likelihood of fulfilling a transportation request using a particular candidate designated location that corresponds to the intersection-location attributes 502.

As further illustrated in FIG. 5, the intersection-location system 104 utilizes a loss function 508 to compare the likelihood of fulfillment 506 with a fulfilled request indicator 510. In particular, the intersection-location system 104 receives the fulfilled request indicator 510 for the transportation request to indicate whether or not the transportation request (e.g., including a designated location with the intersection-location attributes 502) was actually fulfilled. In some embodiments, the intersection-location system 104 utilizes a cross entropy loss function or a mean squared error loss function as the loss function 508.

Based on utilizing the loss function 508 to compare the fulfilled request indicator 510 with the likelihood of fulfillment 506, the intersection-location system 104 further performs a parameter modification 512. In particular, the intersection-location system 104 modifies parameters such as internal weights of the intersection-location machine learning model 504 that adjust how the intersection-location machine learning model 504 analyzes information and generates an output. For instance, if the intersection-location machine learning model 504 generates a relatively high probability of conversion for the likelihood of fulfillment 506, but the fulfilled request indicator 510 indicates that the transportation request was canceled (or otherwise not fulfilled), the intersection-location system 104 modifies parameters of the intersection-location machine learning model 504 to improve its analysis and output generation.

Over time, as the intersection-location system 104 utilizes the intersection-location machine learning model 504 to generate more likelihoods of fulfillment for various transportation requests. Indeed, the intersection-location system 104 repeats the process of training or tuning the intersection-location machine learning model 504 over a number or iterations or epochs to learn parameters for the intersection-location machine learning model 504 to accurately generate outputs, such as likelihoods of fulfillment or conversion probabilities. In some cases, the intersection-location system 104 repeats the process by, for each iteration, identifying subsequent intersection-location attributes from the database 518, generating a subsequent likelihood of fulfillment from the new intersection-location attributes, applying the loss function 508, and performing the parameter modification 512 in accordance with the loss function 508 to improve the accuracy of predicting the likelihood of fulfillment. Thus, the intersection-location system 104 continues to modify parameters and therefore becomes more accurate over the training iterations.

In some embodiments, the intersection-location machine learning model 504 generates the likelihood of fulfillment 506 on a requester-specific basis. To elaborate, in accordance with privacy settings and based on requester opt-in, the intersection-location machine learning model 504 learns preferences of particular requesters. For example, based on a requester opting in to provide such information, the intersection-location system 104 can include requester-specific prior event information as part of the intersection-location attributes 502 to enable the intersection-location machine learning model 504 to generate a likelihood of fulfillment specific to a particular requester. As another example, the intersection-location system 104 can include requester-specific settings regarding a willingness to walk to designated location as part of the intersection-location attributes 502. In these embodiments, the intersection-location machine learning model 504 can thus generate a requester-specific likelihood of fulfillment.

In one or more embodiments, the intersection-location system 104 utilizes the intersection-location machine learning model 504 in conjunction with an objective function 514. More specifically, the intersection-location system 104 determines the likelihood of fulfillment 506 (or the conversion probability) that is included as part of the objective function 514 described above. For instance, intersection-location system 104 utilizes the objective function 514 to determine an expected fulfillment value 516 based on the likelihood of fulfillment 506. In some cases, the intersection-location system 104 utilizes a loss function (as the loss function 508) that is specialized for the objective function 514 and that informs the parameter modification 512 to accomplish a particular objective (e.g., increasing conversions and/or increasing expected fulfillment value). In some cases, for instance, the intersection-location system 104 utilizes a mean square error loss function or a cross entropy loss function as the loss function 508.

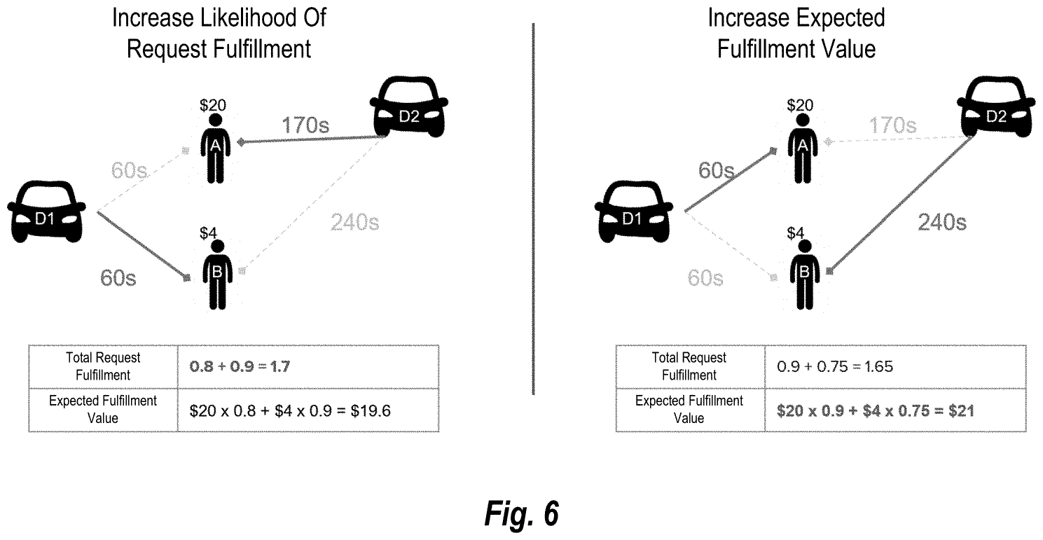

As mentioned above, the intersection-location system 104 can utilize an objective function (e.g., the objective function 514) to select designated locations from candidate designated locations. In particular, the intersection-location system 104 can utilize an objective function to select designated locations that accomplish an objective, such as increasing likelihood of request fulfillment (or conversion probability) and/or increasing an expected fulfillment value. FIG. 6 illustrates a comparison between utilizing the objective function to increase likelihood of request fulfillment and utilizing the objective function to increase expected fulfillment value in accordance with one or more embodiments. While the examples of FIG. 6 illustrate determinations based on predicted arrival times, the intersection-location system 104 can utilize an objective function to increase request fulfillments and/or to increase expected fulfillment value based on additional intersection-location attributes as well.

As illustrated in FIG. 6, the left side illustrates an example for increasing a likelihood of request fulfillment, and the right side illustrates an example for increasing an expected fulfillment value. Referring to the left side, the intersection-location system 104 identifies requester A and requester B, where the fulfillment value (e.g., the profit) associated with the transportation request of requester A is $20, while the fulfillment value associated with a transportation request from requester B is $4. In addition, the intersection-location system 104 identifies two providers, provider D1 and provider D2, that could fulfill either transportation request.

As illustrated on the left side of FIG. 6, the intersection-location system 104 determines a predicted arrival time of 60 seconds for the provider D1 to arrive at a designated location for the transportation request of requester A. Similarly, the intersection-location system 104 determines a predicted arrival time of 60 seconds for the provider D1 to arrive at a designated location for the transportation request of requester B. The intersection-location system 104 further determines predicted arrival times of 170 seconds and 240 seconds for the provider D2 to arrive at designated locations for requester A and requester B, respectively.

Based on the fulfillment values and the predicted arrival times (which can directly impact likelihood of fulfillment), the intersection-location system 104 utilizes the objective function to select which provider to travel to which designated location to fulfill respective transportation requests. As shown, the intersection-location system 104 selects the provider D1 to fulfill the transportation request from the requester B. Conversely, the intersection-location system 104 selects the provider D2 to fulfill the transportation request from the requester A.

Based on this configuration, the intersection-location system 104 determines a total request fulfillment and an expected fulfillment value across multiple transportation requests. For example, the intersection-location system 104 determines a total request fulfillment as a combination of likelihoods of fulfillment for both transportation requests—80% (or 0.8) and 90% (or 0.9), respectively, for a total of 1.7. In addition, the intersection-location system 104 determines an expected fulfillment value based on the depicted configuration. For instance, the intersection-location system 104 determines an expected fulfillment value for each transportation request and combines them together. As shown, the intersection-location system 104 determines each expected fulfillment value as a combination (e.g., a product) of the likelihood of fulfillment and a fulfillment value—that is, $20×0.8 and $4×0.9 for a combined (e.g., summed) total of $19.6.

Referring to the right side of FIG. 6, the intersection-location system 104 determines the same predicted arrival times and fulfillment values for the same providers and requesters as discussed above with reference to the left side. However, to increase expected fulfillment value (as opposed to increasing likelihood of fulfillment), the intersection-location system 104 determines a different configuration of which provider is selected to fulfill which transportation request. Indeed, the intersection-location system 104 selects the provider D1 to navigate to the designated location of the requester A to fulfill a transportation request. The intersection-location system 104 also selects the provider D2 to navigate to the designated location of the requester B to fulfill a transportation request. As shown, the intersection-location system 104 determines likelihoods of fulfillment of 0.9 and 0.75 for the requester A and the requester B, respectively. Additionally, as discussed above, the intersection-location system 104 determines a total request fulfillment of 1.65 and an expected fulfillment value of $21.

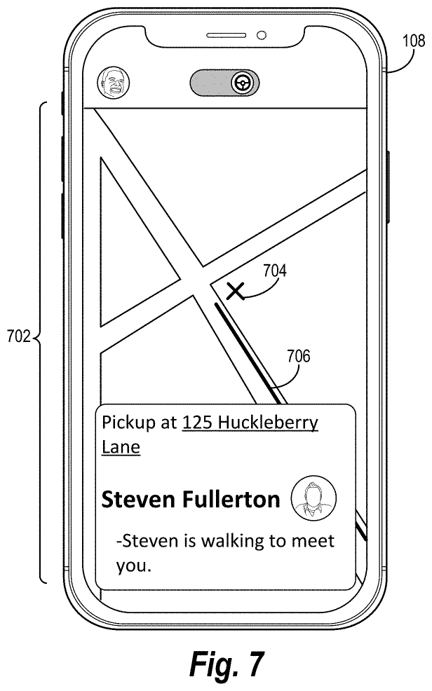

As mentioned above, the intersection-location system 104 can provide a designated-location indicator for display on a client device. In particular, the intersection-location system 104 can provide a designated-location indicator that indicates a designated location within a digital map presented on a client device, such as the provider device 108 or the requester device 112. FIG. 7 illustrates the provider device 108 displaying a designated-location indicator 704 in accordance with one or more embodiments.

As illustrated in FIG. 7, the provider device 108 presents a digital map 702 that includes various interface elements. For example, the digital map 702 includes a designated-location indicator 704 and a route segment 706. Indeed, as described herein, the intersection-location system 104 determines a designated location for a transportation request and provides the designated-location indicator 704 to indicate the designated location. In addition, the intersection-location system 104 generates and provides the route segment 706 to indicate a transportation route from a location of the provider device 108 (as indicated by the open circle) to the designated location (as indicated by the designated-location indicator 704). In some embodiments, the intersection-location system 104 provides the designated-location indicator 704 and the route segment 706 upon selecting the provider associated with the provider device 108 to fulfill the transportation request that includes the designated location.

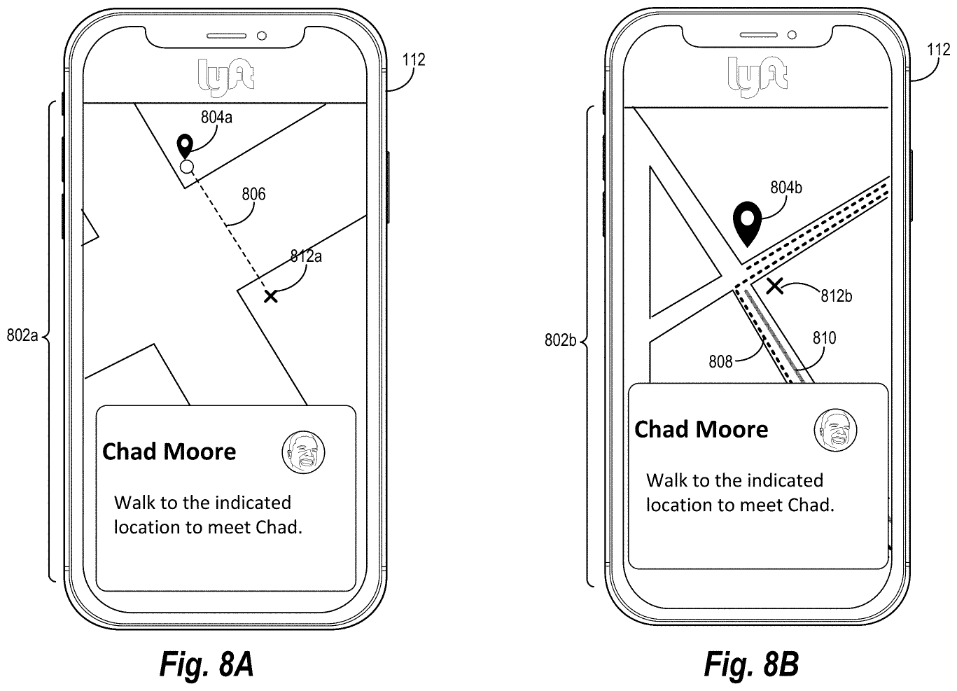

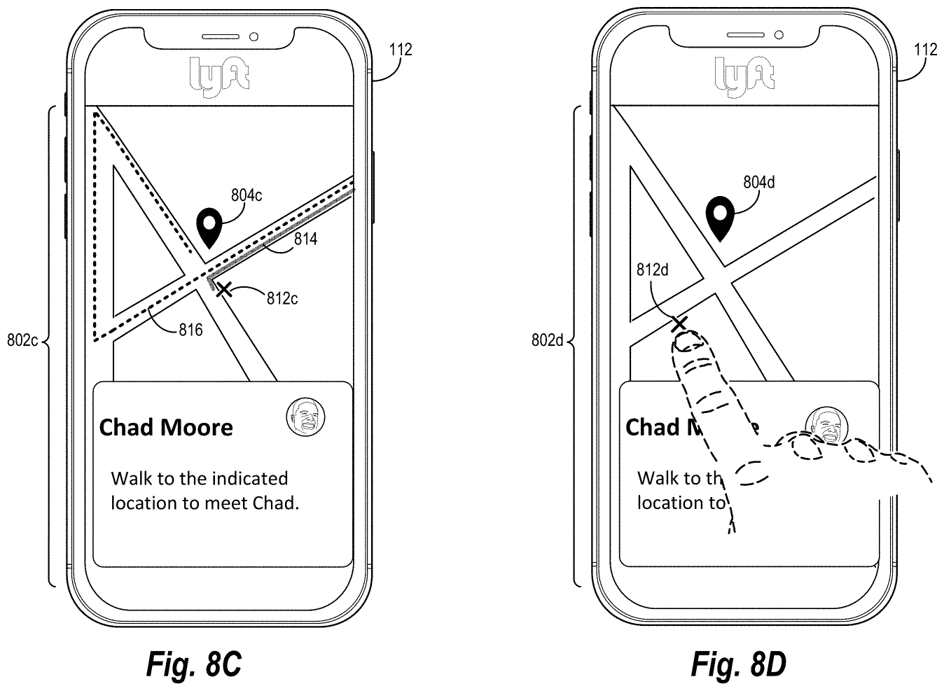

In addition to providing a designated-location indicator (e.g., the designated-location indicator 704) to a provider device (e.g., the provider device 108), the intersection-location system 104 can provide a designated-location indicator for display on a requester device (e.g., the requester device 112). FIGS. 8A-8D illustrate the requester device 112 displaying digital maps that include respective designated-location indicators in accordance with one or more embodiments. In some embodiments, the intersection-location system 104 provides one or more of the digital maps illustrated in FIGS. 8A-8D for display on the requester device 112 for a single transportation request.

As illustrated in FIG. 8A, the requester device 112 displays a digital map 802a that includes a requested-location indicator 804a, a requester-route segment 806, and a designated-location indicator 812a. In particular, for a given transportation request, the intersection-location system 104 selects a designated location at an intersection that requires the requester to walk to arrive at the designated location. As a result, the intersection-location system 104 provides the digital map 802a for display on the requester device 112 to guide the requester to walk from a location of the requester device 112 (indicated by the open circle), which currently coincides with the requested-location indicator 804a, to the designated location indicated by the designated-location indicator 812a. In addition, the intersection-location system 104 provides a prompt to instruct the requester to walk to the designated location (e.g., “Walk to the indicated location to meet Chad”).

As illustrated in FIG. 8B, the requester device 112 displays a digital map 802b that includes a requested-location indicator 804b, a designated-location indicator 812b, an initial route segment 808, and a modified route segment 810. Indeed, based on determining that a transportation request is associated with an intersection, the intersection-location system 104 provides a comparison between the initial route segment 808 and the modified route segment 810.

To elaborate, the intersection-location system 104 generates and provides the initial route segment 808 to indicate part of a transportation route from a location of a transportation vehicle (e.g., a location of the provider device 108) to the requested location corresponding to the requested-location indicator 804b. In addition, the intersection-location system 104 generates and provides the modified route segment 810 to indicate part of a transportation route from a location of the transportation vehicle to the designated location corresponding to the designated-location indicator 812b. Thus, the intersection-location system 104 visually depicts an improvement in route segment straightness and/or predicted arrival time that results from selecting a designated location for an intersection (e.g., to motivate a requester to accept the designated location for the transportation request).

In some embodiments, the intersection-location system 104 provides a post-pickup route segment for display on the requester device 112. FIG. 8C illustrates requester device 112 displaying a digital map 802c that includes post-pickup route segments 814 and 816 in accordance with one or more embodiments. In particular, the intersection-location system 104 provides an initial post-pickup route segment 816 together with a modified post-pickup route segment 814 to illustrate the difference between two possible routes after pick up. The initial post-pickup route segment 816 represents a portion of a transportation route from an event location at the intersection to a subsequent event location for the transportation vehicle (e.g., a subsequent pickup or a drop-off). For example, the initial post-pickup route segment 816 represents a portion of a transportation route from pickup (e.g., at a requested pickup location indicated by the requested-location indicator 804c) to drop-off (e.g., at a requested drop-off location). The modified post-pickup route segment 814 represents a portion of a transportation route from an event location at the intersection (e.g., pickup at a designated location indicated by the designated-location indicator 812c) to a subsequent event location (e.g., drop-off at a requested drop-off location or a designated drop-off location). Thus, the intersection-location system 104 can visually represent the improvement of a designated location in providing a straighter post-pickup transportation route as compared to an initial post-pickup transportation route associated with a requested location.

In one or more embodiments, the intersection-location system 104 enables a requester to accept, reject, or manipulate a designated location. FIG. 8D illustrates a requester manipulating a designated location via a digital map 802d displayed on the requester device 112 in accordance with one or more embodiments. To elaborate, after the intersection-location system 104 selects a designated location for a transportation request, the intersection-location system 104 does not necessarily require the designated location to be used for the transportation request. Rather, the intersection-location system 104 can enable selection and movement of the designated-location indicator 812d by making the designated-location indicator interactive. In some cases, the intersection-location system 104 can provide a prompt for display to ask the requester whether they would like to accept the designated location or use the initial requested location instead. As shown in FIG. 8D, the requester device 112 detects the requester moving the designated-location indicator 812d using a touch gesture to change its placement (e.g., by dragging a designated-location indicator within a digital map or by using another user interaction or input). Upon finalizing a designated location and/or receiving an indication of acceptance or rejection, the intersection-location system 104 either accepts the newly detected location represented by the designated-location indicator or provides the designated-location indicator to the provider device 108 to fulfill the transportation request.

In some embodiments, the intersection-location system 104 re-determines or re-selects a transportation provider based on a requester interaction to move a designated location (e.g., to a new location within a threshold distance of a previously determined designated location). In particular, moving the designated location, as illustrated in FIG. 8D, could make a previously selected provider less practical or less efficient than a different provider based on updated transportation routes for the providers to arrive at the new designated location. Thus, in some embodiments, the intersection-location system 104 re-selects a transportation provider based on the new designated location. If the requester moves the designated-location indicator 812d to a location outside of a threshold distance (e.g., 50 meters) from the intersection or from a previously determined designated location, the intersection-location system 104 re-determines one or more of a new designated location and/or a new provider in accordance with this disclosure.

As just noted, in certain implementations, the intersection-location system 104 can permit a requester to change one or more designated locations for a transportation request, such as by changing a designated pickup location or a designated drop-off location via a graphical user interface of the requester device 112. While the intersection-location system 104 can re-select designated locations and/or providers based on requester interaction with the designated-location indicator 812d, in some cases, the intersection-location system 104 does not re-select a transportation provider and/or a designated location. For example, in certain cases, the intersection-location system 104 does not re-select a transportation provider or a designated location for a pickup event if the requester edits the designated location after a transportation provider and a designated location at a street intersection has been selected (or changed) for the transportation request by the intersection-location system 104. As another example, in some implementations, the intersection-location system 104 does not re-select a provider or a designated location for a drop-off event if a movement of the designated location for drop-off (e.g., moved by the intersection-location system 104 or a requester) is within a threshold distance (e.g., 50 meters).

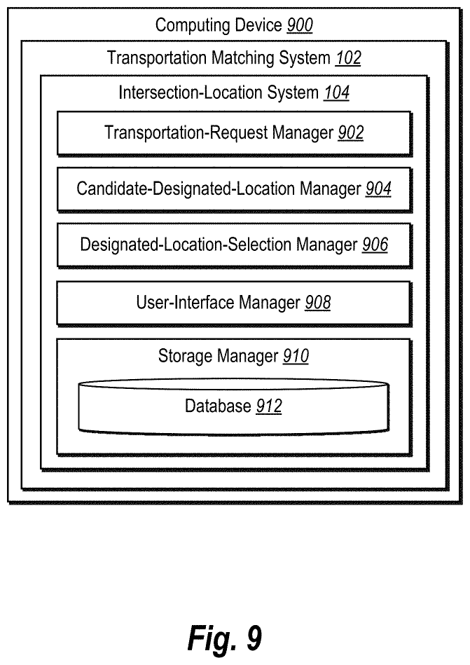

Looking now to FIG. 9, additional detail will be provided regarding components and capabilities of the intersection-location system 104. Specifically, FIG. 9 illustrates an example schematic diagram of the intersection-location system 104 on an example computing device 900 (e.g., one or more of the provider device 108, the requester device 112, and/or the server(s) 106). As shown in FIG. 9, the intersection-location system 104 may include a transportation-request manager 902, a candidate-designated-location manager 904, a designated-location-selection manager 906, a user-interface manager 908, and a storage manager 910.

As just mentioned, the intersection-location system 104 includes a transportation-request manager 902. In particular, the transportation-request manager 902 manages, maintains, receives, analyzes, detects, or identifies transportation requests. For example, the transportation-request manager 902 receives a transportation request and identifies a requested location associated with the transportation request. Particularly, the transportation-request manager 902 determines that the request location is associated with (e.g., within a threshold distance of) a street intersection.

As illustrated in FIG. 9, the intersection-location system 104 includes a candidate-designated-location manager 904. In particular, the candidate-designated-location manager 904 manages, generates, determines, detects, accesses, analyzes, or identifies candidate designated locations. For example, the candidate-designated-location manager 904 communicates with the transportation-request manager 902 to identify an intersection associated with a transportation request. In addition, the candidate-designated-location manager 904 identifies candidate designated locations for the intersection. For instance, the candidate-designated-location manager 904 accesses an intersection template, historical transportation data, and/or analyzes the streets of the intersection to identify placements of candidate designated locations. In addition, the candidate-designated-location manager 904 determines intersection-location attributes and corresponding intersection-location scores associated with the candidate designated locations, as described herein.

Additionally, the intersection-location system 104 includes a designated-location-selection manager 906. In particular, the designated-location-selection manager 906 determines, generates, determines, detects, selects, or identifies designated locations from candidate designated locations. For example, the designated-location-selection manager 906 selects a designated location from among a set of candidate designated locations for a given intersection, based on their respective intersection-location scores. In some embodiments, the designated-location-selection manager 906 utilizes an objective function to select a designated location to accomplish a particular objective (e.g., for the individual transportation request or as part of a larger consideration across multiple transportation requests) such as increasing conversion probability and/or increasing expected fulfillment value.

The intersection-location system 104 also includes a user-interface manager 908. In particular, the user-interface manager 908 manages, maintains, provides, displays, presents, or causes to be displayed user interface elements. For example, the user-interface manager 908 provides a designated-location indicator for display within a digital map presented on a client device. Further, the user-interface manager 908 provides route segments for display, including an initial route segment and a modified route segment, as described herein. In addition, the user-interface manager 908 receives indications of user interaction with various user interface elements. For instance, the user-interface manager 908 receives a user interaction to accept or decline a designated location and/or to manipulate, or modify placement of, a designated location.

Further, the intersection-location system 104 includes a storage manager 910. In particular, the storage manager 910 communicates with other components of the intersection-location system 104 to store and provide various information within or from the database 912 such as requested locations, candidate designated location templates, historical transportation data, an intersection-location machine learning model, and intersection-location attributes.

In one or more embodiments, each of the components of the intersection-location system 104 are in communication with one another using any suitable communication technologies. Additionally, the components of the intersection-location system 104 can be in communication with one or more other devices including one or more client devices described above. It will be recognized that although the components of the intersection-location system 104 are shown to be separate in FIG. 9, any of the subcomponents may be combined into fewer components, such as into a single component, or divided into more components as may serve a particular implementation. Furthermore, although the components of FIG. 9 are described in connection with the intersection-location system 104, at least some of the components for performing operations in conjunction with the intersection-location system 104 described herein may be implemented on other devices within the environment.

The components of the intersection-location system 104 can include software, hardware, or both. For example, the components of the intersection-location system 104 can include one or more instructions stored on a computer-readable storage medium and executable by processors of one or more computing devices (e.g., the computing device 900). When executed by the one or more processors, the computer-executable instructions of the intersection-location system 104 can cause the computing device 900 to perform the methods described herein. Alternatively, the components of the intersection-location system 104 can comprise hardware, such as a special purpose processing device to perform a certain function or group of functions. Additionally or alternatively, the components of the intersection-location system 104 can include a combination of computer-executable instructions and hardware.

Furthermore, the components of the intersection-location system 104 performing the functions described herein may, for example, be implemented as part of a stand-alone application, as a module of an application, as a plug-in for applications including content management applications, as a library function or functions that may be called by other applications, and/or as a cloud-computing model. Thus, the components of the intersection-location system 104 may be implemented as part of a stand-alone application on a personal computing device or a mobile device. Alternatively or additionally, the components of the intersection-location system 104 may be implemented in any application that allows creation and delivery of marketing content to users, including, but not limited to, various applications.

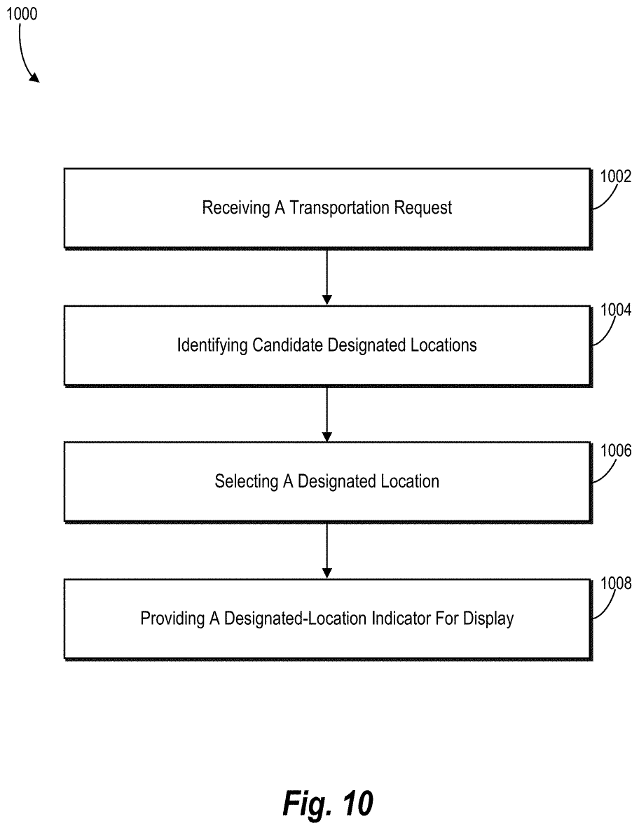

FIGS. 1-9, the corresponding text, and the examples provide a number of different systems, methods, and non-transitory computer readable media for generating and providing a designated-location indicator for a designated location at an intersection. In addition to the foregoing, embodiments can also be described in terms of flowcharts comprising acts for accomplishing a particular result. For example, FIG. 10 illustrates a flowchart of an example sequence of acts in accordance with one or more embodiments.

While FIG. 10 illustrates acts according to some embodiments, alternative embodiments may omit, add to, reorder, and/or modify any of the acts shown in FIG. 10. The acts of FIG. 10 can be performed as part of a method. Alternatively, a non-transitory computer readable medium can comprise instructions, that when executed by one or more processors, cause a computing device to perform the acts of FIG. 10. In still further embodiments, a system can perform the acts of FIG. 10. Additionally, the acts described herein may be repeated or performed in parallel with one another or in parallel with different instances of the same or other similar acts.

FIG. 10 illustrates an example series of acts 1000 for generating and providing a designated-location indicator for a designated location at an intersection. The series of acts 1000 can include an act 1002 of receiving a transportation request. In particular, the act 1002 can involve receiving, from a client device, a transportation request identifying a requested location associated with a street intersection. The act 1002 can involve determining that the transportation request is associated with the street intersection by determining that the requested location is within a threshold distance of the street intersection. In some embodiments, the act 1002 can involve receiving a shared transportation request for multiple requesters to ride in the same transportation vehicle to respective locations.

The series of acts 1000 also includes an act 1004 of identifying candidate designated locations. In particular, the act 1004 can involve, based on the transportation request, identifying a plurality of candidate designated locations at the street intersection for one or more transportation routes. For example, the act 1004 can involve identifying locations within a threshold distance of the street intersection.

Further, the series of acts 1000 includes an act 1006 of selecting a designated location. In particular, the act 1006 can involve selecting, from among the plurality of candidate designated locations, a designated location for a transportation route based on a plurality of intersection-location attributes corresponding to the street intersection. The act 1006 can involve determining intersection-location attributes for the plurality of candidate designated locations by determining, for a candidate designated location, two or more of (or three or more of): a predicted arrival time for a transportation vehicle selected to fulfill the transportation request to arrive at the candidate designated location, a walking distance for a requester to arrive at the candidate designated location, a likelihood that the transportation vehicle will have to move from the candidate designated location before the requester arrives at the candidate designated location, a likelihood that the transportation vehicle will make a wrong turn while navigating to the candidate designated location, or a predicted straightness for a route segment associated with a transportation route including the candidate designated location.

In some embodiments, the act 1006 can involve determining two or more of (or three or more of) additional intersection-location attributes as well, such as: a number of streets for the requester to cross to arrive at the candidate designated location, widths of one or more streets for the requester to cross to arrive at the candidate designated location, a number of medians for the requester to cross to arrive at the candidate designated location, a number of train tracks for the requester to cross to arrive at the candidate designated location, a number of stop lights for the requester to navigate to arrive at the candidate designated location, or an indication of whether the transportation vehicle will pass by the requester in route to the candidate designated location.

The act 1006 can involve comparing predicted arrival times. In addition, the act 1006 can involve selecting a location across a street of the street intersection from the requested location to reduce a number of turns required for a transportation vehicle to arrive at the designated location. The requested location can include a requested pickup location, and the designated location can include a designated pickup location for a transportation vehicle to pick up a requester associated with the client device. Alternatively, the requested location can include a requested drop-off location, and the designated location can include a designated drop-off location for a transportation vehicle to drop off a requester associated with the client device. In some embodiments, the act 1006 can involve selecting the designated location based on a predicted straightness for the route segment of a corresponding transportation route.

As shown, the series of acts 1000 includes an act 1008 of providing a designated-location indicator for display. In particular, the act 1008 can involve providing, for display on the client device, a designated-location indicator marking the designated location within a digital map. In some embodiments, the act 1008 can involve providing, for display on the client device: an initial route segment indicating a transportation route for a transportation vehicle to navigate to the requested location and a modified route segment indicating a transportation route for the transportation vehicle to navigate to the designated location.

The series of acts 1000 can also include an act of weighting the plurality of intersection-location attributes in accordance with an objective function to reduce transportation-request cancelations. In some embodiments, the series of act 1000 includes an act of comparing predicted arrival times for a plurality of transportation providers to arrive at the plurality of candidate designated locations. Additionally, the series of acts includes an act of selecting, from among the plurality of transportation providers, a transportation provider to fulfill the transportation request based on comparing the predicted arrival times.

In one or more embodiments, the series of acts 1000 includes an act of weighting the intersection-location attributes in accordance with an objective function to reduce transportation-request cancelations. The series of acts 1000 can also include an act of determining intersection-location scores for the plurality of candidate designated locations based on weighting the intersection-location attributes. Further, the series of acts 1000 can include acts of ranking the plurality of candidate designated locations based on the intersection-location scores and selecting a highest-ranked candidate designated location as the designated location for the transportation request.

In some embodiments, the series of acts 1000 includes an act of determining, utilizing an intersection-location machine learning model and based on the intersection-location attributes, conversion probabilities that requesters are transported by various transportation vehicles to or from particular candidate designated locations in fulfillment of transportation requests. The series of acts 1000 can also include an act of selecting the designated location for the transportation route based on the conversion probabilities. Further, the series of acts 1000 can include an act of determining, based on the intersection-location attributes, conversion probabilities and fulfillment values for requesters being transported by various transportation vehicles to or from particular candidate designated locations in fulfillment of transportation requests.

Additionally, the series of acts 1000 can include an act of generating expected fulfillment values across different combinations of transportation vehicles, requesters, and candidate designated locations utilizing an objective function based on the conversion probabilities and fulfillment values. The series of acts 1000 can also include an act of selecting the designated location for the transportation route based on the expected fulfillment values across the different combinations of transportation vehicles, requesters, and candidate designated locations. The series of acts 1000 can further include acts of determining an incremental-transportation value for fulfilling a transportation request and, based on the incremental-transportation value, the conversion probabilities, and the fulfillment values, generating the expected fulfillment values across the different combinations of transportation vehicles, requesters, and candidate designated locations utilizing the objective function.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary computing device 1100 (e.g., the provider device 108, the requester device 112, or the server(s) 106) that may be configured to perform one or more of the processes described above. One will appreciate that the intersection-location system 104 can comprise implementations of the computing device 1100, including, but not limited to, the provider device 108 and/or the server(s) 106. As shown by FIG. 11, the computing device can comprise a processor 1102, memory 1104, a storage device 1106, an I/O interface 1108, and a communication interface 1110. In certain embodiments, the computing device 1100 can include fewer or more components than those shown in FIG. 11. Components of computing device 1100 shown in FIG. 11 will now be described in additional detail.

In particular embodiments, processor(s) 1102 includes hardware for executing instructions, such as those making up a computer program. As an example, and not by way of limitation, to execute instructions, processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, storage device 1106 can comprise a non-transitory storage medium described above. The storage device 1106 may include a hard disk drive (“HDD”), flash memory, a Universal Serial Bus (“USB”) drive or a combination of these or other storage devices.

The computing device 1100 also includes one or more input or output interface 1108 (or “I/O interface 1108”), which are provided to allow a user (e.g., requester or provider) to provide input to (such as user strokes), receive output from, and otherwise transfer data to and from the computing device 1100. These I/O interface 1108 may include a mouse, keypad or a keyboard, a touch screen, camera, optical scanner, network interface, modem, other known I/O devices or a combination of such I/O interface 1108. The touch screen may be activated with a stylus or a finger.

The I/O interface 1108 may include one or more devices for presenting output to a user, including, but not limited to, a graphics engine, a display (e.g., a display screen), one or more output providers (e.g., display providers), one or more audio speakers, and one or more audio providers. In certain embodiments, interface 1108 is configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices 1100 or one or more networks. As an example, and not by way of limitation, communication interface 1110 may include a network interface controller (“NIC”) or network adapter for communicating with an Ethernet or other wire-based network or a wireless NIC (“WNIC”) or wireless adapter for communicating with a wireless network, such as a WI-FI. The computing device 1100 can further include a bus 1112. The bus 1112 can comprise hardware, software, or both that connects components of computing device 1100 to each other.

FIG. 12 illustrates an example network environment 1200 of the transportation matching system 102. The network environment 1200 includes a client device 1206 (e.g., the provider device 108 or the requester device 112), a transportation matching system 102, and a vehicle subsystem 1208 connected to each other by a network 1204. Although FIG. 12 illustrates a particular arrangement of the client device 1206, the transportation matching system 102, the vehicle subsystem 1208, and the network 1204, this disclosure contemplates any suitable arrangement of client device 1206, the transportation matching system 102, the vehicle subsystem 1208, and the network 1204. As an example, and not by way of limitation, two or more of client device 1206, the transportation matching system 102, and the vehicle subsystem 1208 communicate directly, bypassing network 1204. As another example, two or more of client device 1206, the transportation matching system 102, and the vehicle subsystem 1208 may be physically or logically co-located with each other in whole or in part.

Moreover, although FIG. 12 illustrates a particular number of client devices 1206, transportation matching systems 102, vehicle subsystems 1208, and networks 1204, this disclosure contemplates any suitable number of client devices 1206, transportation matching system 102, vehicle subsystems 1208, and networks 1204. As an example, and not by way of limitation, network environment 1200 may include multiple client device 1206, transportation matching system 102, vehicle subsystems 1208, and/or networks 1204.

This disclosure contemplates any suitable network 1204. As an example, and not by way of limitation, one or more portions of network 1204 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1204 may include one or more networks 1204.

Links may connect client device 1206, intersection-location system 104, and vehicle subsystem 1208 to network 1204 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1200. One or more first links may differ in one or more respects from one or more second links.

In particular embodiments, the client device 1206 may be an electronic device including hardware, software, or embedded logic components or a combination of two or more such components and capable of carrying out the appropriate functionalities implemented or supported by client device 1206. As an example, and not by way of limitation, a client device 1206 may include any of the computing devices discussed above in relation to FIG. 11. A client device 1206 may enable a network user at the client device 1206 to access network 1204. A client device 1206 may enable its user to communicate with other users at other client devices 1206.

In particular embodiments, the client device 1206 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1206 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1206 one or more Hyper Text Markup Language (“HTML”) files responsive to the HTTP request. The client device 1206 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 102 may be a network-addressable computing system that can host a transportation matching network. The transportation matching system 102 may generate, store, receive, and send data, such as, for example, user-profile data, concept-profile data, text data, transportation request data, GPS location data, provider data, requester data, vehicle data, or other suitable data related to the transportation matching network. This may include authenticating the identity of providers and/or vehicles who are authorized to provide transportation services through the transportation matching system 102. In addition, the transportation matching system 102 may manage identities of service requesters such as users/requesters. In particular, the transportation matching system 102 may maintain requester data such as driving/riding histories, personal data, or other user data in addition to navigation and/or traffic management services or other location services (e.g., GPS services).

In particular embodiments, the transportation matching system 102 may manage transportation matching services to connect a user/requester with a vehicle and/or provider. By managing the transportation matching services, the transportation matching system 102 can manage the distribution and allocation of resources from vehicle systems and user resources such as GPS location and availability indicators, as described herein.

The transportation matching system 102 may be accessed by the other components of network environment 1200 either directly or via network 1204. In particular embodiments, the transportation matching system 102 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1206, or a transportation matching system 102 to manage, retrieve, modify, add, or delete, the information stored in data store.

In particular embodiments, the transportation matching system 102 may provide users with the ability to take actions on various types of items or objects, supported by the transportation matching system 102. As an example, and not by way of limitation, the items and objects may include transportation matching networks to which users of the transportation matching system 102 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 102 or by an external system of a third-party system, which is separate from transportation matching system 102 and coupled to the transportation matching system 102 via a network 1204.

In particular embodiments, the transportation matching system 102 may be capable of linking a variety of entities. As an example, and not by way of limitation, the transportation matching system 102 may enable users to interact with each other or other entities, or to allow users to interact with these entities through an application programming interfaces (“API”) or other communication channels.

In particular embodiments, the transportation matching system 102 may include a variety of servers, sub-systems, programs, modules, logs, and data stores. In particular embodiments, the transportation matching system 102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile or requester profile) store, connection store, third-party content store, or location store. The transportation matching system 102 may also include suitable components such as network interfaces, security mechanisms, load balancers, failover servers, management-and-network-operations consoles, other suitable components, or any suitable combination thereof. In particular embodiments, the transportation matching system 102 may include one or more user-profile stores for storing user profiles for transportation providers and/or transportation requesters. A user profile may include, for example, biographic information, demographic information, behavioral information, social information, or other types of descriptive information, such as interests, affinities, or location.

The web server may include a mail server or other messaging functionality for receiving and routing messages between the transportation matching system 102 and one or more client devices 1206. An action logger may be used to receive communications from a web server about a user's actions on or off the transportation matching system 102. In conjunction with the action log, a third-party-content-object log may be maintained of user exposures to third-party-content objects. A notification controller may provide information regarding content objects to a client device 1206. Information may be pushed to a client device 1206 as notifications, or information may be pulled from client device 1206 responsive to a request received from client device 1206. Authorization servers may be used to enforce one or more privacy settings of the users of the transportation matching system 102. A privacy setting of a user determines how particular information associated with a user can be shared. The authorization server may allow users to opt in to or opt out of having their actions logged by the transportation matching system 102 or shared with other systems, such as, for example, by setting appropriate privacy settings. Third-party-content-object stores may be used to store content objects received from third parties. Location stores may be used for storing location information received from client devices 1206 associated with users.

In addition, the vehicle subsystem 1208 can include a human-operated vehicle or an autonomous vehicle. A provider of a human-operated vehicle can perform maneuvers to pick up, transport, and drop off one or more requesters according to the embodiments described herein. In certain embodiments, the vehicle subsystem 1208 can include an autonomous vehicle—e.g., a vehicle that does not require a human operator. In these embodiments, the vehicle subsystem 1208 can perform maneuvers, communicate, and otherwise function without the aid of a human provider, in accordance with available technology.

In particular embodiments, the vehicle subsystem 1208 may include one or more sensors incorporated therein or associated thereto. For example, sensor(s) can be mounted on the top of the vehicle subsystem 1208 or else can be located within the interior of the vehicle subsystem 1208. In certain embodiments, the sensor(s) can be located in multiple areas at once e.g., split up throughout the vehicle subsystem 1208 so that different components of the sensor(s) can be placed in different locations in accordance with optimal operation of the sensor(s). In these embodiments, the sensor(s) can include motion-related components such as an inertial measurement unit (“IMU”) including one or more accelerometers, one or more gyroscopes, and one or more magnetometers. The sensor(s) can additionally or alternatively include a wireless IMU (“WIMU”), one or more cameras, one or more microphones, or other sensors or data input devices capable of receiving and/or recording information relating to navigating a route to pick up, transport, and/or drop off a requester.

In particular embodiments, the vehicle subsystem 1208 may include a communication device capable of communicating with the client device 1206 and/or the intersection-location system 104. For example, the vehicle subsystem 1208 can include an on-board computing device communicatively linked to the network 1204 to transmit and receive data such as GPS location information, sensor-related information, requester location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, from a client device, a transportation request identifying a requested location associated with a street intersection;
based on the transportation request, identifying a plurality of candidate designated locations at the street intersection for one or more transportation routes;
selecting, from among the plurality of candidate designated locations, a designated location for a transportation route based on a plurality of intersection-location attributes corresponding to the street intersection; and
providing, for display on the client device, a designated-location indicator marking the designated location within a digital map.

2. The method of claim 1, further comprising determining that the transportation request is associated with the street intersection by determining that the requested location is within a threshold distance of the street intersection.

3. The method of claim 1, further comprising determining intersection-location attributes for the plurality of candidate designated locations by determining, for a candidate designated location, two or more of:
a predicted arrival time for a transportation vehicle selected to fulfill the transportation request to arrive at the candidate designated location;
a walking distance for a requester to arrive at the candidate designated location;
a likelihood that the transportation vehicle will have to move from the candidate designated location before the requester arrives at the candidate designated location;
a likelihood that the transportation vehicle will make a wrong turn while navigating to the candidate designated location; or
a predicted straightness for a route segment associated with a transportation route including the candidate designated location.

4. The method of claim 1, further comprising weighting the plurality of intersection-location attributes in accordance with an objective function to reduce transportation-request cancelations.

5. The method of claim 1, further comprising:
comparing predicted arrival times for a plurality of transportation providers to arrive at the plurality of candidate designated locations;
selecting, from among the plurality of transportation providers, a transportation provider to fulfill the transportation request based on comparing the predicted arrival times; and
wherein selecting the designated location for the transportation route is based on comparing the predicted arrival times.

6. The method of claim 1, wherein selecting the designated location for the transportation request comprises selecting a location across a street of the street intersection from the requested location to reduce a number of turns required for a transportation vehicle to arrive at the designated location.

7. The method of claim 1, wherein the requested location comprises a requested pickup location and the designated location comprises a designated pickup location for a transportation vehicle to pick up a requester associated with the client device.

8. A system comprising:
at least one processor; and
a non-transitory computer readable medium comprising instructions that, when executed by the at least one processor, cause the system to:
receive, from a client device, a transportation request identifying a requested location associated with a street intersection;
based on the transportation request, identify a plurality of candidate designated locations at the street intersection for one or more transportation routes;
select, from among the plurality of candidate designated locations, a designated location for a transportation route based on a plurality of intersection-location attributes corresponding to the street intersection; and
provide, for display on the client device, a designated-location indicator marking the designated location within a digital map.

9. The system of claim 8, further comprising instructions that, when executed by the at least one processor, cause the system to determine intersection-location attributes for the plurality of candidate designated locations by determining, for a candidate designated location, two or more of:
a predicted arrival time for a transportation vehicle selected to fulfill the transportation request to arrive at the candidate designated location;
a walking distance for a requester to arrive at the candidate designated location;
a likelihood that the transportation vehicle will have to move from the candidate designated location before the requester arrives at the candidate designated location;
a likelihood that the transportation vehicle will make a wrong turn while navigating to the candidate designated location; or
a predicted straightness for a route segment associated with a transportation route including the candidate designated location.

10. The system of claim 8, further comprising instructions that, when executed by the at least one processor, cause the system to:
receive the transportation request by receiving a shared transportation request for multiple requesters to ride in the same transportation vehicle to respective locations; and
select the designated location based on a predicted straightness for the route segment of a corresponding transportation route.

11. The system of claim 8, further comprising instructions that, when executed by the at least one processor, cause the system to:
weight the intersection-location attributes in accordance with an objective function to reduce transportation-request cancelations; and
determine intersection-location scores for the plurality of candidate designated locations based on weighting the intersection-location attributes.

12. The system of claim 11, further comprising instructions that, when executed by the at least one processor, cause the system to:
rank the plurality of candidate designated locations based on the intersection-location scores; and
select a highest-ranked candidate designated location as the designated location for the transportation request.

13. The system of claim 8, wherein the requested location comprises a requested drop-off location and the designated location comprises a designated drop-off location for a transportation vehicle to drop off a requester associated with the client device.

14. A non-transitory computer readable medium comprising instructions that, when executed by at least one processor, cause a computing device to:
receive, from a client device, a transportation request identifying a requested location associated with a street intersection;
based on the transportation request, identify a plurality of candidate designated locations at the street intersection for one or more transportation routes;
select, from among the plurality of candidate designated locations, a designated location for a transportation route based on a plurality of intersection-location attributes corresponding to the street intersection; and
provide, for display on the client device, a designated-location indicator marking the designated location within a digital map.

15. The non-transitory computer readable medium of claim 14, further comprising instructions that, when executed by the at least one processor, cause the computing device to identify the plurality of candidate designated locations at the street intersection by identifying locations within a threshold distance of the street intersection.

16. The non-transitory computer readable medium of claim 14, further comprising instructions that, when executed by the at least one processor, cause the computing device to provide, for display on the client device:
an initial route segment indicating a transportation route for a transportation vehicle to navigate to the requested location; and
a modified route segment indicating a transportation route for the transportation vehicle to navigate to the designated location.

17. The non-transitory computer readable medium of claim 14, further comprising instructions that, when executed by the at least one processor, cause the computing device to:
determine, utilizing an intersection-location machine learning model and based on the intersection-location attributes, conversion probabilities that requesters are transported by various transportation vehicles to or from particular candidate designated locations in fulfillment of transportation requests; and
select the designated location for the transportation route based on the conversion probabilities.

18. The non-transitory computer readable medium of claim 14, further comprising instructions that, when executed by the at least one processor, cause the computing device to:
determine, based on the intersection-location attributes, conversion probabilities and fulfillment values for requesters being transported by various transportation vehicles to or from particular candidate designated locations in fulfillment of transportation requests;
generate expected fulfillment values across different combinations of transportation vehicles, requesters, and candidate designated locations utilizing an objective function based on the conversion probabilities and fulfillment values; and
select the designated location for the transportation route based on the expected fulfillment values across the different combinations of transportation vehicles, requesters, and candidate designated locations.

19. The non-transitory computer readable medium of claim 18, further comprising instructions that, when executed by the at least one processor, cause the computing device to:
determine an incremental-transportation value for fulfilling a transportation request; and
based on the incremental-transportation value, the conversion probabilities, and the fulfillment values, generate the expected fulfillment values across the different combinations of transportation vehicles, requesters, and candidate designated locations utilizing the objective function.

20. The non-transitory computer readable medium of claim 14, determine intersection-location attributes for the plurality of candidate designated locations by determining, for a candidate designated location, two or more of:
a predicted arrival time for a transportation vehicle selected to fulfill the transportation request to arrive at the candidate designated location;
a walking distance for a requester to arrive at the candidate designated location;
a likelihood that the transportation vehicle will have to move from the candidate designated location before the requester arrives at the candidate designated location;
a likelihood that the transportation vehicle will make a wrong turn while navigating to the candidate designated location;
a number of streets for the requester to cross to arrive at the candidate designated location;
widths of one or more streets for the requester to cross to arrive at the candidate designated location;
a number of medians for the requester to cross to arrive at the candidate designated location;
a number of train tracks for the requester to cross to arrive at the candidate designated location;
a number of stop lights for the requester to navigate to arrive at the candidate designated location;
an indication of whether the transportation vehicle will pass by the requester in route to the candidate designated location; or
a predicted straightness for a route segment associated with a transportation route including the candidate designated location.
